(19) United States
(12) Patent Application Publication
(10) Pub. No.: US 2026/0163692 A1
(43) Pub. Date: Jun. 11, 2026

(54) METHODS, ARCHITECTURES, APPARATUSES AND SYSTEMS FOR SELECTION OF A REFERENCE SIGNAL FOR CHANNEL IMPULSE RESPONSE ESTIMATION

(71) Applicant: InterDigital Patent Holdings, Inc., Wilmington, DE (US)

(72) Inventors: Javier Lorca Hernando, Madrid (ES); Yasser Mestrah, Uxbridge (GB); Arman Shojaeifard, London (GB); Mohammad Heggo, Lewisham (GB); Alain Mourad, Ascot (GB)

(21) Appl. No.: 18/976,202

(22) Filed: Dec. 10, 2024

(51) Int. Cl. H04L 5/00; H04B 17/20; H04L 25/02; H04W 24/10

(52) U.S. Cl. CPC H04L 5/0048; H04B 17/202; H04L 25/0212; H04W 24/10

(57) ABSTRACT

A wireless transmit/receive unit (WTRU) may select one or more reference signal (RS) configurations for a localization and/or sensing task to mitigate effects of possible channel impairments. The WTRU may receive a first set of information indicating a plurality of configurations for sensing or localization operations. The WTRU may receive a first RS and may determine a second set information about the first RS. The second set of information may comprise channel variation information over a time period. The WTRU may select a configuration of the plurality of configurations based on the second information and may be configured based on the selected configuration. The WTRU may receive a second RS and may perform a sensing or localizing operation, using the configuration based on the selected configuration, to generate a third set of information based on the second RS. The WTRU may transmit the third set information to the wireless network.

### TECHNICAL FIELD

The present disclosure is generally directed to the fields of communications, software and encoding, including, for example, to methods, architectures, apparatuses, systems related to selecting one or more reference signal (RS) configurations for localization and/or sensing operations.

### SUMMARY

In accordance with certain representative embodiments of the present disclosure, methods and systems are provided for selecting, by a wireless transmit/receive unit (WTRU), one or more RS configurations for a localization and/or sensing task to mitigate the effect of possible channel impairments. In certain representative embodiments, a WTRU may receive a first information indicating a plurality of configurations for at least one of sensing operations or localization operations. The WTRU may receive, from the wireless network, a first RS. The WTRU may determine a second information about the first RS, wherein the second information comprises channel variation information over a period of time. Channel variation information comprises one or more of a doppler shift, doppler spread, position, or velocity within the measurement period of any of the line of sight (LOS)/multipath components (MPC). The WTRU may select a configuration of the plurality of configurations based on the second information. The WRTU may be configured based on the selected configuration. The WTRU may receive, from the wireless network, a second RS. The WTRU may perform at least one of the sensing operations or the localizing operations, using the configuration based on the selected configuration, to generate a third information based on the second RS. The third information may indicate at least one of a LOS/MPC, channel variation information over a measurement window, a recommended size of a channel impulse response (CIR) interval, a recommended number of RS versions per CIR interval, estimated signal-to-noise ratio gain per CIR interval, or RS version configurations. The WTRU may transmit the third information to the wireless network.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A shows a system diagram illustrating an example communications system, according to one or more embodiments of this disclosure;

FIG. 1B shows a system diagram illustrating an example wireless transmit/receive unit (WTRU) that may be used within the communications system illustrated in FIG. 1A, according to one or more embodiments of this disclosure;

FIG. 1C shows a system diagram illustrating an example radio access network (RAN) and an example core network (CN) that may be used within the communications system illustrated in FIG. 1A, according to one or more embodiments of this disclosure;

FIG. 1D shows a system diagram illustrating a further example RAN and a further example CN that may be used within the communications system illustrated in FIG. 1A, according to one or more embodiments of this disclosure;

FIG. 2 shows an exemplary channel impulse response (CIR) estimate around a multipath component (MPC), according to one or more embodiments of this disclosure;

FIG. 3 shows exemplary RS versions exhibiting a certain comb size in the time-frequency grid, according to one or more embodiments of this disclosure;

FIG. 4A shows an illustrative example of a cyclic frequency shift (CFS) controlling the steepness of phase variations with low signal-to-noise (SNR) and low delay uncertainty conditions, according to one or more embodiments of this disclosure;

FIG. 4B shows an illustrative example of a CFS controlling the steepness of phase variations with high SNR and low delay uncertainty conditions, according to one or more embodiments of this disclosure;

FIG. 5 shows an illustrative example of a pseudo-random frequency hopping pattern being used to overcome unpredictable channel fades, according to one or more embodiments of this disclosure;

FIG. 6 shows a diagram of illustrative actions performed by a WTRU and transmit-receive point (TRP) for a WTRU-assisted selection of RS versions for CIR estimation in localization and sensing, according to one or more embodiments of this disclosure;

FIG. 7 shows a flowchart of illustrative steps for a WTRU-assisted selection of RS versions for CIR estimation, according to one or more embodiments of this disclosure;

FIG. 8 shows an illustrative report containing the characteristics of the recommended RS versions by the WTRU for up to a certain number of LOS/MPC components, according to one or more embodiments of this disclosure;

FIG. 9 shows a diagram of illustrative actions performed by a WTRU and TRP for localization or sensing measurements based on RS versions, according to one or more embodiments of this disclosure;

FIG. 10 shows a flowchart of illustrative steps for localization or sensing measurements performed by a WTRU based on RS versions, according to one or more embodiments of this disclosure; and

FIG. 11 shows a flowchart of illustrative steps for selecting a RS configuration, according to one or more embodiments of this disclosure.

### DETAILED DESCRIPTION OF THE DRAWINGS

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device and/or any element thereof carries out an operation, process, algorithm, function and/or any portion thereof, it is to be understood that any embodiments described and/or claimed herein assume that any apparatus, system, device and/or any element thereof is configured to carry out any operation, process, algorithm, function and/or any portion thereof.

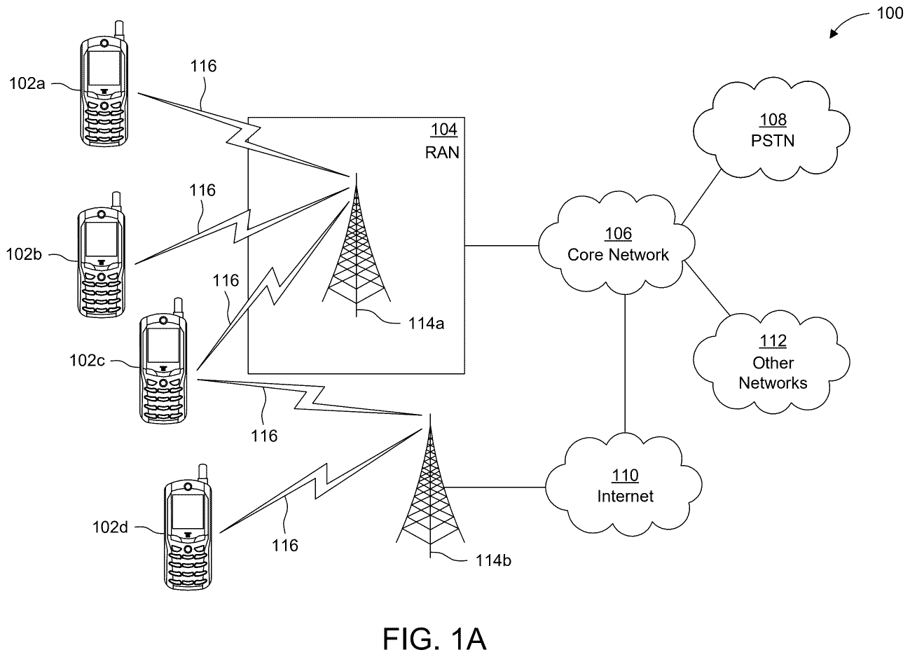

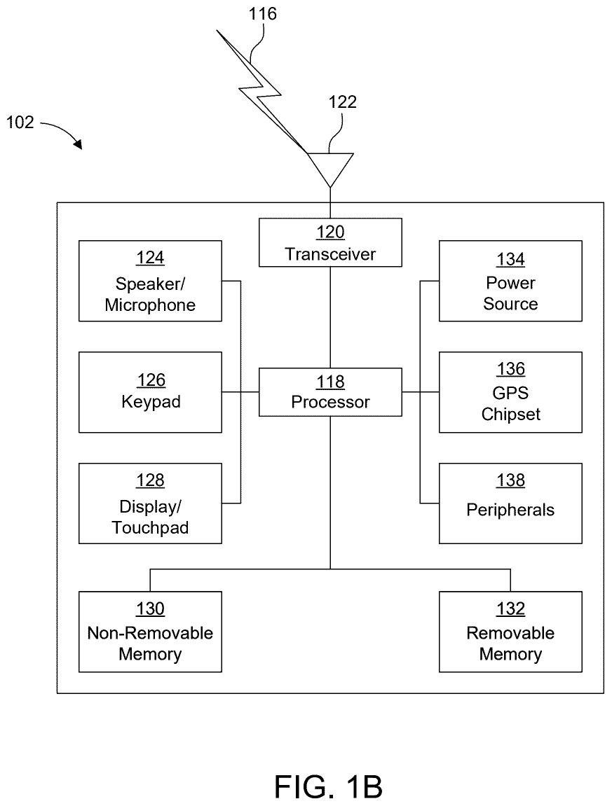

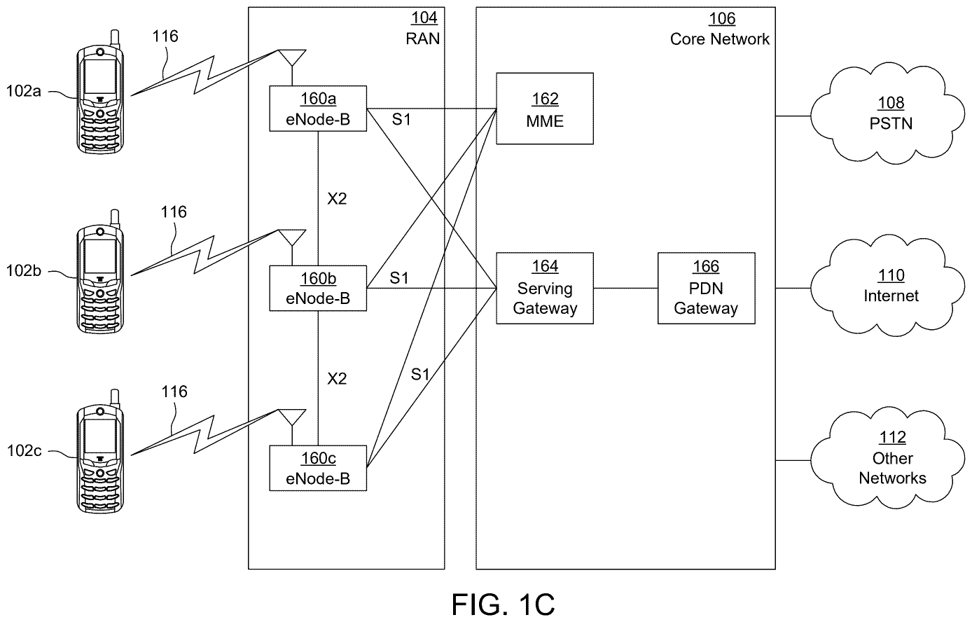

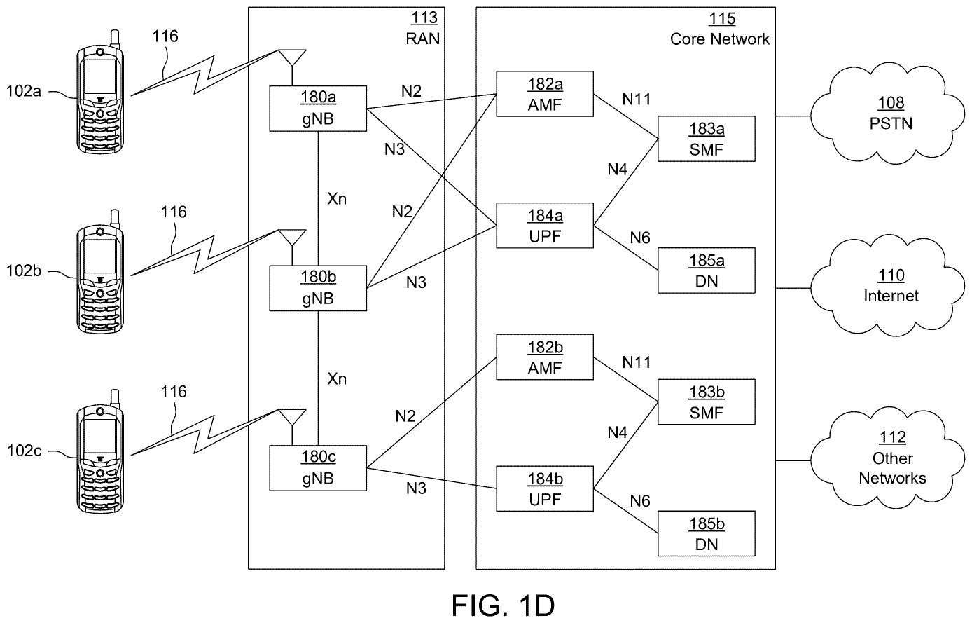

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, or broadcast to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa, e.g., if the WTRU includes only one active UE.

As used herein, a sensing device may refer to any device that can perform sensing based on a wireless signal, including but not limited to any of the WTRUs 102a, 102b, 102c and 102d, any UE, any base station (e.g., base station 114a of RAN 104, or base station 114b), any suitable eNode-B (e.g., any eNode-B 160a, 160b, or 160c), any suitable gNode-B (e.g., any gNode-B 180a, 180b, or 180c), any hardware of a core network (e.g., hardware configured to execute any access and mobility function (AMF), user plane function (UPF), session management function (SMF) or data network (DN) of a core network), or any other suitable device. In this disclosure, a sensing device may be interchangeably referred to as a sensor, a sensor node, or a sensing node.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), or relay nodes. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, or NR) to establish any of a small cell, picocell or femtocell. As shown in FIG. 1A, the base station 114b may have a direct connection to the Internet 110. Thus, the base station 114b need not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion)), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode need not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, or entity.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards UPFs 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one SMF 183a, 183b, and at least one DN 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The MME 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1E is a block diagram illustrating an example of an ISF that may be executed on processing equipment coupled to communication equipment and that may be used within the communications system illustrated in FIG. 1A according to some embodiments of this disclosure. The ISF 190 of FIG. 1E can be part of RAN 104 or 113, a part of core network 106 or 115, a part of other networks 112, or any other suitable part (e.g., node) of a wireless network. The ISF 190 can be any suitable hardware, software, or both, for implementing the functionality of the ISF 190 as described in the present disclosure. As shown, ISF 190 may include processing equipment 191 to execute the logic of ISF 190 as described in the present disclosure. For example, processing equipment 191 may determine how to reconfigure sensing devices for performing an ongoing sensing task. Communication equipment 192 may be included among the hardware that executes ISF 190 to send and receive data between ISF 190 and any other suitable sensing device (e.g., between ISF 190 and one or more of WTRUs 102a, 102b, 102c, or 102d, RAN 104, core network 106, any suitable UE, any suitable base station 114, any suitable fusion device, any other device executing a function of a wireless network, or any combination thereof). It will be understood that ISF 190 may include one or more physical hardware components that may be distributed. For example, if the ISF 190 is implemented at any one or more of the NEF, AMF, SMF, or RAN, then the hardware of ISF 190 would be the same as the hardware of the one or more of the NEF, AMF, SMF, or RAN. It will also be understood that the ISF 190 is one illustrative and non-limiting function that may be used to perform a distributed sensing task with sensing device reconfiguration.

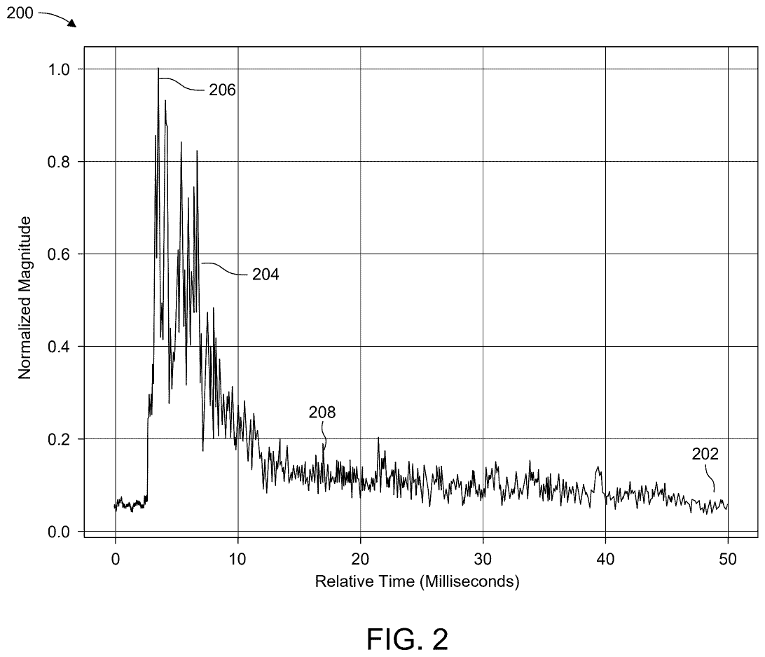

In accordance with some embodiments of this disclosure, the devices and systems of FIGS. 1A-1D may be used in connection with devices, systems, and methods for selection of a reference signal for channel impulse response estimation. For example, the devices and systems of FIGS. 1A-1D may be used in connection with the devices, systems, and methods described in FIGS. 2-11, in some embodiments of this disclosure.

In accordance with some embodiments of this disclosure, sensing hereinafter refers to the estimation of one or more spatial characteristics (e.g., the absolute or relative position, 3D orientation, speed) of one or multiple objects that are not connected to the system under consideration. In some embodiments, sensing may be considered a usage scenario (e.g., when considering integrated sensing and communications (ISAC)). In certain representative embodiments, localization relates to the estimation of one or more spatial characteristics of one or multiple devices wirelessly connected to the system under consideration such as a WTRU. It is to be understood that reference to a WTRU may include any one or more suitable WTRUs such as one or more of WTRUs 102a, 102b, 102c, 102d and may be used interchangeably with any of the terms UE, sensing device, or sensing receiver. It is to be understood that a sensing transmitter may be used interchangeably with any of the terms TRP, base station, or gNB. It is to be understood that reference to a base station may include any one or more suitable base stations such as one or more of base stations 114a, 114b. It is to be understood that reference to a gNB may include any one or more suitable gNBs such as one or more of 180a, 180b, 180c.

In certain representative embodiments, when performing positioning and/or sensing measurements, the channel impulse response may need to be estimated from a suitable RS (e.g., positioning reference signal (PRS) or sounding reference signal for positioning (SRSp)), via correlations. CIR characterizes the effect of a channel on a transmitted signal and captures how the signal's amplitude and phase change as it travels through the channel. It represents the way a channel responds to a signal over time and provides a time-domain representation of the response of a wireless channel to a transmitted signal. CIR may be used in positioning and sensing tasks (e.g., line of sight (LOS)/non-line of sight (NLOS) identification). In certain representative embodiments, the receiving entity may then leverage the CIR to estimate reference signal received power per path (RSRPP), reference signal received power (RSRP), reference signal carrier phase (RSCP), time of arrival (ToA), time difference of arrival (TDoA), angle of arrival (AoA), or other relevant metrics at the relevant MPC peaks. The RS is assumed to exhibit good correlation properties to yield a spreading gain, equivalent to an SNR gain, which may be dependent on its length. The RS configuration used in localization or sensing impacts the achievable accuracy.

In certain representative embodiments, several aspects may impact the CIR estimation from the aggregated copies of the received RS signal. In an example, deep channel fades may cause the channel's frequency response to be degraded at certain subcarriers because of the presence of frequency-selective fading. CIR aggregation may lead to minor improvements at those subcarriers leading to distorted MPC shapes at the CIR, with the corresponding loss of information. Another example may be small-scale channel variations such that the phase of the CIR may change over short timescales due to Doppler (i.e., different for different MPC peaks), phase noise, beam misalignments, or other variations. In certain representative embodiments, CIR phase changes may be seen graphically at 204. If the positioning or sensing measurements span a time interval that is comparable, or higher, than the channel's coherence time, aggregation may yield a degraded CIR because of phase cancellation between the received signal replicas. In an example, limited time resolution such that time-varying phases may appear at the MPC peaks due to the implicit Dirichlet shapes of the ideal delta function when CIR is sampled with a resolution given by the RS bandwidth below the fast Fourier transform (FFT) size may impact CIR estimation. In an example, signals from other users, such as those in the positioning or sensing area that are using the same resources, may distort the CIR, leading to reduced SNR and inaccurate estimates for parameters (e.g., ToA, AoA, RSRP). Additionally, inter-symbol interference might appear when the delay spread exceeds the cyclic prefix duration which may be caused by trailing samples from past RS that are reflected by distant objects. In an example, non-linearities caused by non-ideal hardware components may impact CIR estimation. In an example, thermal or additive noise may impact CIR estimation.

In certain representative embodiments, NR positioning framework allows repetitions of PRS/SRSp symbols at the same or different resources so that the receiver may combine CIRs for additional noise reduction. Relevant PRS/SRSp configuration parameters for doing so include the position, bandwidth, comb size, comb offset, number of symbols, muting pattern, and periodicity.

FIG. 2 shows an exemplary CIR estimate around an MPC, according to one or more embodiments of this disclosure. In certain representative embodiments, CIR estimation may be subject to thermal noise. For example, exemplary CIR response 200 may have CIR estimate 202. Thermal noise may be mitigated by performing signal aggregation over multiple symbols exploiting some form of repetitions and/or redundancies of the positioning and/or sensing RS. However, when a channel is not ideal and suffers from small-scale fast channel variations (e.g., from mobility) or deep fades (e.g., from frequency selectivity), aggregation may suffer from phase cancellation or insufficient SNR. As a result, CIR estimation may be impaired. Examples of aspects impacting the CIR estimation from the aggregated copies of the received RS signal may include thermal noise, deep channel fades, small-scale channel variations, limited time resolution, interference, or hardware non-linearities. In an example, aspects impacting CIR estimation such as thermal noise, deep channel fades, small-scale channel variations, limited time resolution, interference, or hardware non-linearities may manifest in CIR estimate 202 as region 204. Limited time resolution may manifest as region 206. Additive noise may manifest as region 208 on CIR estimate 202. These aspects impair CIR estimation from combining aggregated copies obtained from the different RS repetitions, or RS instances, even if the sensing metrics to be acquired (e.g., ToA, AoA, RSRPP) remain constant over the measurement and/or estimation period. In certain representative embodiments, the resulting CIR from the combination of RS instances exhibits a lower SNR than would be expected in perfect coherent superposition (i.e., if the complex CIR samples would add up coherently). Thus, it may be desirable to achieve accurate CIR estimation based on a multiplicity of versions (e.g., full or partial) of the transmitted RS signal in the presence of deep fades, small-scale channel variations, limited time resolution, interference, or other impairments.

In certain representative embodiments, a WTRU capable of receiving reference signals and performing measurements for localization or sensing purposes is configured by the network with more than one set of RS configurations and triggering conditions for measurement and reporting (e.g., a target variation metric) in a localization or sensing task, wherein each set of RS configurations may have distinct parameters in time and/or frequency density and may be associated with a range of supported channel variations (e.g., a Doppler shift) for a given measurement quality metric (e.g., a ToA error). In certain representative embodiments, a WTRU receives a first RS and reports the corresponding localization or sensing measurements. In certain representative embodiments, a WTRU measures a channel variation metric over a preconfigured time interval (e.g., a Doppler shift, a variation over time of a phase, RSRPP, delay) and, if it exceeds a configured threshold, reports one or more of the channel variation metric, a recommended set of RS configurations, and a size of the CIR interval, based on the target variation metric, the measured channel variation, and the configuration. In certain representative embodiments, a WTRU is configured with parameters of a second RS including one or more RS configurations and a size of the CIR interval (e.g., a number of slots) and reports the localization or sensing measurements per each CIR interval or measurements for all intervals following a-priori known or configured criteria. In certain representative embodiments, a WTRU reports the absolute or relative performance difference obtained on the second RS with respect to the first RS (e.g., as a percent improvement). In certain representative embodiments, a WTRU sends an indication to update or stop the transmission of a second RS based on a change in the measured channel variation or the localization or sensing performance.

In certain representative embodiments, a WTRU capable of receiving reference signals and performing measurements on them for localization or sensing purposes is configured by a network with one or more RS configurations in a localization or sensing task, wherein each RS configuration may have distinct parameters in time and/or frequency density and may be associated with a range of supported channel variations (e.g., a Doppler shift) for a given measurement quality metric (e.g., a ToA error). In certain representative embodiments, a WTRU is configured by a network to receive a RS for localization or sensing including one or more RS configurations and a size of the CIR interval (e.g., a number of symbols). In certain representative embodiments, a WTRU performs the localization or sensing measurements on the received RS and reports the results per each CIR interval, or combined for all intervals, following a-priori known or configured criteria.

In certain representative embodiments, a cellular scenario is considered comprising one or more sensing transmitters (e.g., a TRP) and one or more measurement entities, or sensing receivers (e.g., UE, WTRU), both acting as transmitting or receiving entities for localization and/or sensing depending on service needs.

In certain representative embodiments, DL localization or sensing may involve a WTRU receiving signals from one or more sensing transmitters (e.g., a TRP, base station, gNB), performing localization or sensing measurements to derive spatial information about itself and the surrounding objects (e.g., the location, speed, orientation) as determined by the system or the application, and reporting them to the network. UL localization or sensing may involve one or more TRPs receiving signals from one or more transmitting WTRUs and performing the necessary tasks to locate the WTRU or the target to be sensed.

In an example, in a bistatic sensing scenario, a sensing transmitter sends reference signals that are captured by a sensing receiver with the goal of determining the location and characteristics of one or more targets in the environment (e.g., position, orientation, velocity, object type such as pedestrian or car, object dimension, object materials). The sensing receiver may also be impacted by reflections or diffractions from clutter (e.g., the ground, a tree) and from other objects (e.g., non-target related) existing in the same environment as the target object or target objects. A multistatic sensing scenario may comprise multiple sensing receivers whose sensing measurements are collected by a network.

In certain representative embodiments, a sensing transmitter comprises of any number of transmit-receive antennas (e.g., in a massive multiple input—multiple output (M-MIMO) configuration) with up to N antenna ports for the transmission of sensing signals. A WTRU may be equipped with one or multiple receive antennas.

In certain representative embodiments, it is assumed that a suitable RS already exists for sensing measurements, either in the form of an existing signal that is re-purposed for sensing (e.g., the DL Positioning Reference Signal (PRS) or the UL Sounding Reference Signal for Positioning (SRSp) in 5G NR) or a dedicated sensing reference signal. The suitable RS that already exists for sensing measurements may be referred to as a first RS for localization and/or sensing.

Descriptions hereinafter are applicable to any waveform comprising discrete samples that can be analysed by suitable subcarriers in the frequency domain (e.g., via application of Discrete Fourier Transforms (DFT) such as cyclic prefix—orthogonal frequency division multiplexing (CP-OFDM), discrete Fourier transforms—spread—orthogonal frequency division multiplexing (DFT-s-OFDM), constant envelope—orthogonal frequency division multiplexing (CE-OFDM), single carrier—frequency domain equalization (SCd-FDE)) and do not preclude other waveforms.

In certain representative embodiments, a WTRU may receive information about the reference signal resources that may be relevant for the signaling and reporting of a localization or sensing task a WTRU.

In certain representative embodiments, an RS may be used to perform both localization and sensing. This unification may simplify the system design and reduce the overhead associated with managing multiple signals, leading to more efficient use of resources. From the network side, a node (e.g., gNB, location management function (LMF)) may coordinate the resources for both localization and sensing. In an example, the WTRU may receive a configuration to perform one or more localization and sensing task (e.g., a RS configuration and a measurement configuration). In certain representative embodiments, a measurement configuration may also include one or more of common measurements used for localization and sensing, event triggers, triggered actions, assistance information, or thresholds.

In certain representative embodiments, the RS may be configured separately for a localization or sensing task, with one RS dedicated to sensing (e.g., channel state information—reference signal (CSI-RS), a sensing RS) and the other RS to localization (e.g., PRS, SRS-P). This separation allows for the design and optimization of each RS according to its specific requirements, potentially enhancing the accuracy and performance of both localization and sensing tasks.

In certain representative embodiments, from the network side, a node may perform a localization task (e.g., LMF) and another node may perform a sensing task (e.g., gNB, a sensing function), which may require some communication between the two nodes. In an example, a WTRU may receive distinct configurations to perform localization and sensing tasks separately, including RS configuration, measurement configuration, event triggers, triggered actions, or other similar tasks.

In certain representative embodiments, RS versions are described as variations of a transmitted RS aimed to better cope with impairments when performing localization or sensing measurements for CIR estimation by the sensing receiver.

In certain representative embodiments, RS versions for CIR estimation may be obtained from multiplication of the time-domain RS with a function selected among a family of RS version functions {Fⱼ(m), m=0, . . . , L−1}, where L is the number of subcarriers allocated to the user (e.g., user bandwidth). The index j may start from 0 up to the size of a pre-defined set of functions (e.g., a codebook). In certain representative embodiments, RS version functions may be described as configuration options for the available RS versions.

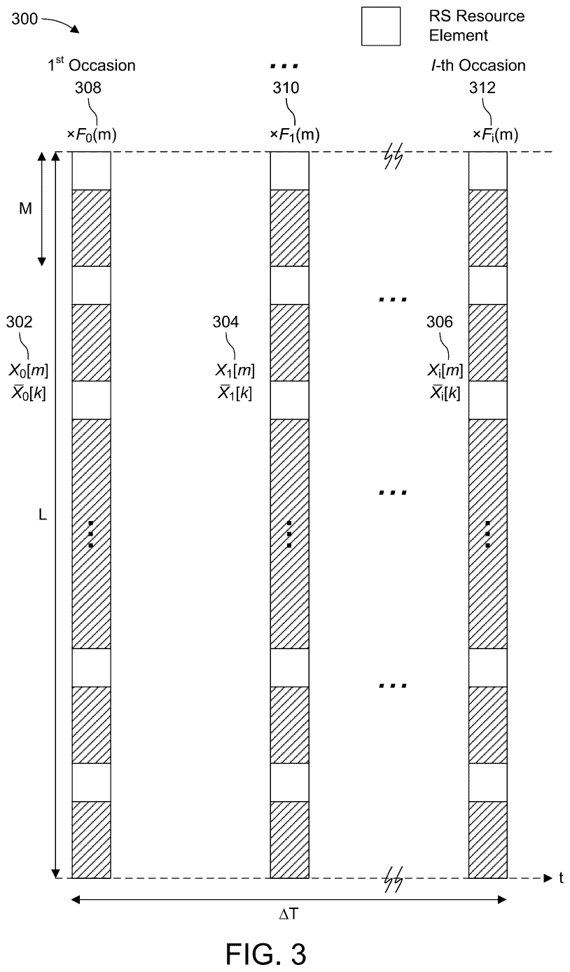

FIG. 3 illustrates exemplary RS versions exhibiting a comb size M in the time-frequency grid, according to one or more embodiments of this disclosure. For example, RS versions 300 may be transmitted on the same symbol based on different resource sets. In certain representative embodiments, an i-th transmitted RS version (e.g., transmitted version 302, 304, 306) may be expressed as Xᵢ[m]=S[m]F₁(m), and in frequency, X̅ᵢ[k]=S[k]⊗_{L} F̅ᵢ[k] where ⊗_{L} denotes an L-point circular convolution. RS versions may be allocated different sets of resources (e.g., resource sets), each comprising a set of different time, frequency, code and/or space resources. The complete RS transmission in a given symbol may comprise of a multiplicity of RS versions (e.g., up to J RS versions), each defined by an RS version function and a resource set. For example, a function for an i-th RS version can be defined by

$${F}_{i} ( m ) = {e}^{j 2 π \frac{{a}_{i}}{L} m} , \qquad ( eq . 1 )$$

where aᵢ is a cyclic frequency shift (CFS) expressed as an integer within the user's allocated bandwidth, 0≤aᵢ<L. RS versions 308, 310, 312 may be defined by eq. (1). The correlation properties of the localization and/or sensing RS should remain unchanged in the RS versions. In an example, multiplication of the RS with a complex exponential may keep the signal contents unchanged (only altering the frequency allocations), while introducing a time-domain linear progressive phase that can be beneficial for CIR estimation. Other functions may be possible for defining the RS versions (e.g. complex exponentials with a non-linear progressive phase).

In certain representative embodiments, focusing on a target MPC peak, the transmitter entity may send a RS signal, S[m], from which up to j RS versions can be defined in the same symbol. The J RS Versions in a symbol may yield up to j CIRs, CIR₁, . . . , CIR_{J}, as per the different resource sets used.

In certain representative embodiments, CIRs may benefit from phase randomization because of the RS Version functions. Focusing on one time symbol, one or more metrics (e.g., ToA, AoA, RSCP) are intended to be measured. The total received signal in one symbol is a superposition of the J received RS Versions.

In certain representative embodiments, CIRs may benefit from phase randomization because of the version functions. Focusing on one time symbol, one or more metrics (ToA, AoA, RSCP) may be measured. The total received signal in one symbol is a superposition of the J received RS Versions,

$$Y [ m ] = {\sum }_{i = 1}^{J} {Y}_{i} [ m ] , \qquad ( eq . 2 )$$

where Yᵢ[m] corresponds to the i-th received RS Version which can be written as:

$${Y}_{i} [ m ] = ( S [ m ] {F}_{i} ( m ) ) {⊗}_{L} {h}_{i} [ m ] + {n}_{0 , i} = {\sum }_{j = 0}^{L - 1} {h}_{i , j} S [ m - j ] {F}_{i} ( m - j ) + {n}_{0 , i} [ m ] , \qquad ( eq . 3 )$$

$$where {h}_{i} [ m ] = {\sum }_{j = 0}^{L - 1} {h}_{i , j} δ [ m - j ]$$

may be the i-th CIR with multipath complex amplitudes h_{i,j}, and n_{0,i}[m] may be an additive white Gaussian noise (AWGN) noise term with power N₀.

In certain representative embodiments, the goal of the receiver may be to estimate CIRs at each symbol to perform localization or sensing measurements. In an example, the receiver may perform aggregation of the CIRs in one symbol, or in multiple symbols, prior to the localization or sensing measurements. In an example, the receiver may individually perform the localization or sensing measurements per each of the obtained CIRs.

In certain representative embodiments, to estimate CIRᵢ, the receiver entity may leverage the correlation properties of the transmitted RS. In an example, the receiver may perform correlations of the received signal Y[m] with shifted replicas of the transmitted signal S[m] multiplied by the RS Version function shifted by the delay at the targeted MPC peak (e.g., Fᵢ(m−bᵢ)). The MPC delay bᵢ may be assumed to be known by the receiver from a previous sensing measurement and may be generally subject to errors. The correlation Rᵢ may be written as:

$${R}_{i} [ τ ] = {\sum }_{m = 0}^{L - 1} Y [ m ] {S}^{*} [ m - τ ] {F}_{i}^{*} ( m - {b}_{i} ) = {\underbrace{{\sum }_{m = 0}^{L - 1} {\sum }_{j = 0}^{L - 1} {h}_{i , j} S [ m - j ] {F}_{i} ( m - j ) {S}^{*} [ m - τ ] {F}_{i}^{*} ( m - {b}_{i} )}}_{autocorrelation} + {\sum }_{{i}^{′} \neq i} {\underbrace{{\sum }_{m = 0}^{L - 1} {\sum }_{j = 0}^{L - 1} {h}_{{i}^{′} , j} S [ m - j ] {F}_{{i}^{′}} ( m - j ) {S}^{*} [ m - τ ] {F}_{i}^{*} ( m - {b}_{i} )}}_{cross - correlation} + {\sum }_{{i}^{′} = 1}^{J} {\underbrace{{\sum }_{m = 0}^{L - 1} {S}^{*} [ m - τ ] {F}_{{i}^{′}}^{*} ( m - {b}_{i} ) {n}_{0 , {i}^{′}} [ m ]}}_{noise {W}_{{i}^{′}}} . \qquad ( eq . 4 )$$

In eq. (4), apart from a noise term, there may appear cross-correlation terms in addition to the autocorrelation term. The appearance of cross-correlation terms in addition to the autocorrelation term may be caused by interactions between the RS version functions when performing detection. To benefit from these terms, version functions may be designed to satisfy certain properties. In an example, the RS version functions may fulfil

$${F}_{i} ( x ) {F}_{i}^{*} ( y ) = {F}_{i} ( x - y ) , \qquad ( eq . 5 )$$

$${F}_{i} ( x ) {F}_{{i}^{′}}^{*} ( x ) = {F}_{i - {i}^{′}} ( x ) , \qquad ( eq . 6 )$$

$$then$$

$${CIR}_{i} [ τ ] ∝ {R}_{i} [ τ ] = {\sum }_{m = 0}^{L - 1} {\sum }_{j = 0}^{L - 1} {h}_{i , j} S [ m - j ] {S}^{*} [ m - τ ] {F}_{i} ( {b}_{i} - j ) + {\sum }_{{i}^{′} \neq i} {\sum }_{m = 0}^{L - 1} {\sum }_{j = 0}^{L - 1} {h}_{{i}^{′} , j} S [ m - j ] {S}^{*} [ m - τ ] {F}_{{i}^{′} - i} ( {b}_{i} - j ) + {\sum }_{{i}^{′} = 1}^{J} {W}_{{i}^{′}} = K \{ {h}_{i , τ} {F}_{i} ( {b}_{i} - τ ) + {\sum }_{\begin{matrix}{i}^{′} = 1 \\ {i}^{′} \neq i\end{matrix}}^{J} {h}_{{i}^{′} , τ} {F}_{{i}^{′} - i} ( {b}_{i} - τ ) \} + {\sum }_{{i}^{′} = 1}^{J} {W}_{{i}^{′}} . \qquad ( eq . 7 )$$

The latter comes from the correlation properties of RS: ΣₘS[m−j]S*[m−τ]=Kδ(j−τ), where K is the spreading gain of the RS.

In certain representative embodiments, in consequence, when up to J RS versions are transmitted in a symbol, cross terms i′≠i may appear in the CIR containing products of h_{i′,τ} and F_{i′-i}.

In certain representative embodiments, regarding the noise

$${W}_{{i}^{′}} = {\sum }_{m = 0}^{L - 1} {S}^{*} [ m - τ ] {F}_{{i}^{′}}^{*} ( m - {b}_{{i}^{′}} ) {n}_{0} [ m ]$$

in eq. (7), the terms in the summation are Gaussian and uncorrelated, hence the terms are also independent. The variance of the sum may be the sum of the variances, and the noise power will be equal to JKN₀. Then, measuring at the MPC peak where the values

$$\vert {h}_{{i}^{′} , {b}_{{i}^{′}}} \vert$$

can be considered approximately equal for all i′, the SNR at the output of the i-th correlator may be related to the SNR at the input by:

$${SNR}_{i} = \frac{{J}^{2} {K}^{2} {\vert {h}_{i , {b}_{i}} \vert}^{2}}{{JKN}_{0}} = JKSNR . \qquad ( eq . 8 )$$

In certain representative embodiments, the CIR obtained from the i-th RS version may have an SNR improvement given by the product of the RS spreading gain (K) and the number of RS versions in a symbol (J).

In certain representative embodiments, CIRs obtained from RS versions may be coherently combined within a symbol, and also over multiple symbols, to yield a combined CIR.

In certain representative embodiments, a set of J CIRs within a symbol may be coherently combined to achieve a single aggregated CIR. In an example, MRC combining of CIRs involves a weighted sum with coefficients given by the conjugates of the channel responses at the MPC peak,

$${h}_{i , {b}_{i}}^{*} ,$$

yielding:

$$CIR [ τ ] = {\sum }_{i = 1}^{J} {h}_{i , {b}_{i}}^{*} {CIR}_{i} [ τ ] = K {\sum }_{i = 1}^{J} {h}_{i , {b}_{i}}^{*} \{ {h}_{i , τ} {F}_{i} ( {b}_{i} - τ ) + {\sum }_{\begin{matrix}{i}^{′} = 1 \\ {i}^{′} \neq i\end{matrix}}^{J} {h}_{{i}^{′} , τ} {F}_{{i}^{′} - i} ( {b}_{i} - τ ) \} + {\underbrace{{\sum }_{{i}^{′} = 1}^{J} {\sum }_{i = 1}^{J} {h}_{i , {b}_{i}}^{*} {W}_{{i}^{′}}}}_{W} = K \{ {\sum }_{i = 1}^{J} {h}_{i , {b}_{i}}^{*} {h}_{i , τ} {F}_{i} ( {b}_{i} - τ ) + {\sum }_{i = 1}^{J} {\sum }_{\begin{matrix}{i}^{′} = 1 \\ {i}^{′} \neq i\end{matrix}}^{J} {h}_{i , {b}_{i}}^{*} {h}_{{i}^{′} , τ} {F}_{{i}^{′} - i} ( {b}_{i} - τ ) \} + W . \qquad ( eq . 9 )$$

In certain representative embodiments if version functions satisfy the additional properties

$$\vert {\sum }_{i = 1}^{J} {F}_{i} ( x ) \vert {\to }_{\vert x \vert ≃ 0} J , \qquad ( eq . 10 )$$

$$\vert {\sum }_{i = 1}^{J} {F}_{i} ( x ) \vert {\to }_{\vert x \vert ≫ 0} 0 , \qquad ( eq . 11 )$$

then, samples away from the MPC peak may to cancel each other in eq. (9), while those at the MPC peak will have a power reinforced by J⁴|h_{i,b}_{ᵢ}|⁴. The noise W has a noise power reinforced by J²|h_{i,b}_{ᵢ}|². Therefore, the combined SNR may be:

$${SNR}_{comb} = \frac{{K}^{2} {J}^{4} {\vert {h}_{i , {b}_{i}} \vert}^{4}}{{KJ}^{2} {N}_{0} {\vert {h}_{i , {b}_{i}} \vert}^{2}} = {J}^{2} KSNR . \qquad ( eq . 12 )$$

In certain representative embodiments, other combining strategies may give similar results. In consequence, the combined CIR obtained from the RS versions in a symbol may have an SNR gain given by the product of the RS spreading gain (K) and the square of the number of RS versions in it (J²).

In certain representative embodiments, RS version functions may be defined in multiple ways to satisfy different requirements. If functions satisfy eq. (5), eq. (6), eq. (10) and eq. (11), then detection may involve simple correlations and the CIRs obtained from the RS versions in a symbol may benefit from an increased SNR as in eq. (8) or eq. (12).

In an example, the family of exponentials

$${F}_{i} ( x ) = {e}^{j 2 π \frac{{a}_{i}}{L} x} ,$$

where aᵢ=iM, i=0, . . . , (L−1)/M, satisfy eq. (5), eq. (6), eq. (10) and eq. (11). The CFS value iM based on a comb size M may determine the slope of the phase variations. These functions may satisfy

$$\vert {\sum }_{i} {e}^{j 2 π \frac{iM}{L} x} \vert {\to }_{\vert x \vert ≫ 0} 0$$

with a higher speed of convergence for higher CFS values. Other version functions may also be considered.

In certain representative embodiments, CFS may be a phase slope that may control how far from the estimated MPC peak the CIR phases tend to cancel each other when aggregating the CIRs.

In an example, a high uncertainty in the delay determination (e.g., from a high estimation error) may motivate the use of version functions with low CFS values, to allow some noise reduction over a wider area around the, possibly poorly, estimated delay. In contrast, a lower delay uncertainty may allow higher CFS values (e.g., depending on the SNR) to sharpen the CIR more precisely around the, possibly better, estimated delay such as in the exemplary table below:

| SNR or RSRPP | Delay uncertainty | CFS |
|---|---|---|
| Low | Low | Moderate |
| High | Low | High |
| Low | High | Low |
| High | High | Low |

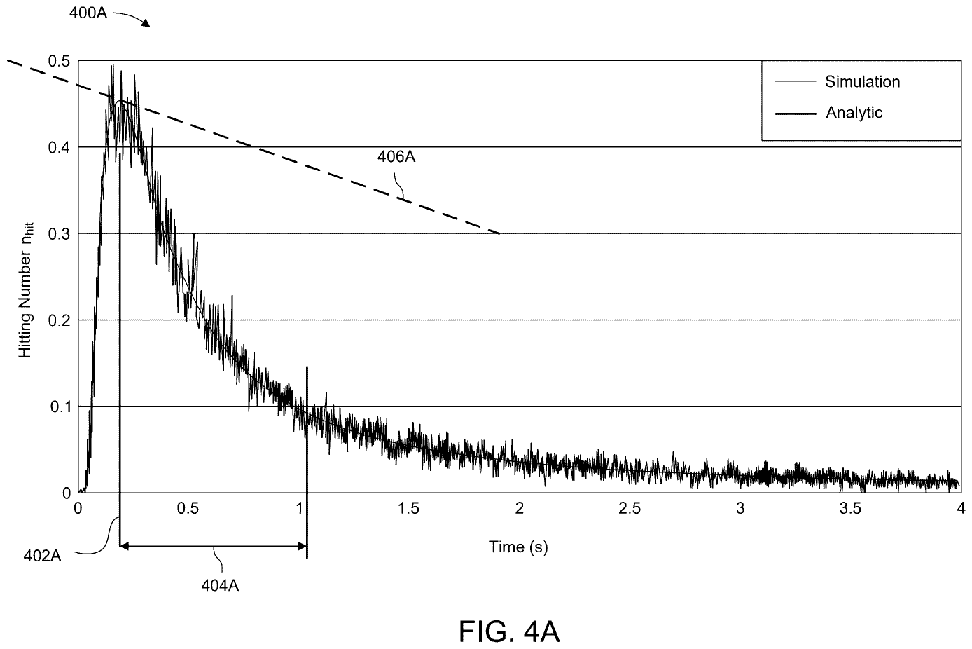

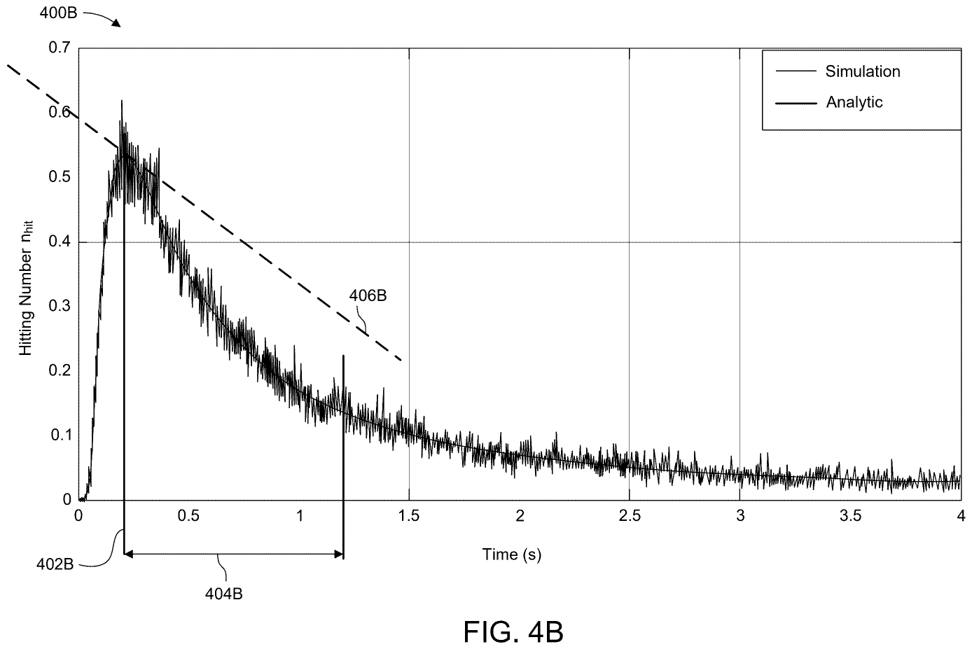

FIG. 4A shows an illustrative example 400A of a CFS controlling the steepness of phase variations with low SNR and low delay uncertainty conditions, according to one or more embodiments of this disclosure. In 400A, a moderate CFS value may be chosen by the WTRU and result in phase slope 406A. The measured values may have some bᵢ 402A with δ 404A.

FIG. 4B shows an illustrative example 400B of a CFS controlling the steepness of phase variations with high SNR and low delay uncertainty conditions, according to one or more embodiments of this disclosure. In 400B, a high CFS value may be chosen by the WTRU and result in phase slope 406B. The measured values may have some bᵢ 402B with δ 404B.

In certain representative embodiments, a CFS may be chosen by the WTRU such that the phase variations are not significant in a time region around the target MPC peak equal to the ToA error, where phases are not intended to change much after the CIR superposition.

In certain representative embodiments, in consequence, a selection strategy for RS version functions within a symbol may be based on the absolute phase difference between any two functions being equal or higher than a threshold for an argument equal to the estimated ToA error of the target MPC. Other similar strategies may be devised depending on the version functions and the implementation.

In certain representative embodiments, the comb size, comb offset, bandwidth, subcarrier start, repetition factor, time gap, and number of symbols may be dynamically changed at the i-th RS version to better exploit frequency diversity in the presence of deep signal fades. In an example, Reducing the comb size (M) or increasing the user bandwidth (L) may improve accuracy as per the Cramer-Rao lower bound (CRLB) of the ranging/position estimation:

$$CRLB ∝ \frac{1}{( {( \frac{L}{M} )}^{2} SNR )} .$$

In an example, shifting the symbol position in the slot, the comb offset D, and/or and the subcarrier start may help mitigate the impact of deep fades. The resulting patterns may be regular, irregular or pseudo-random.

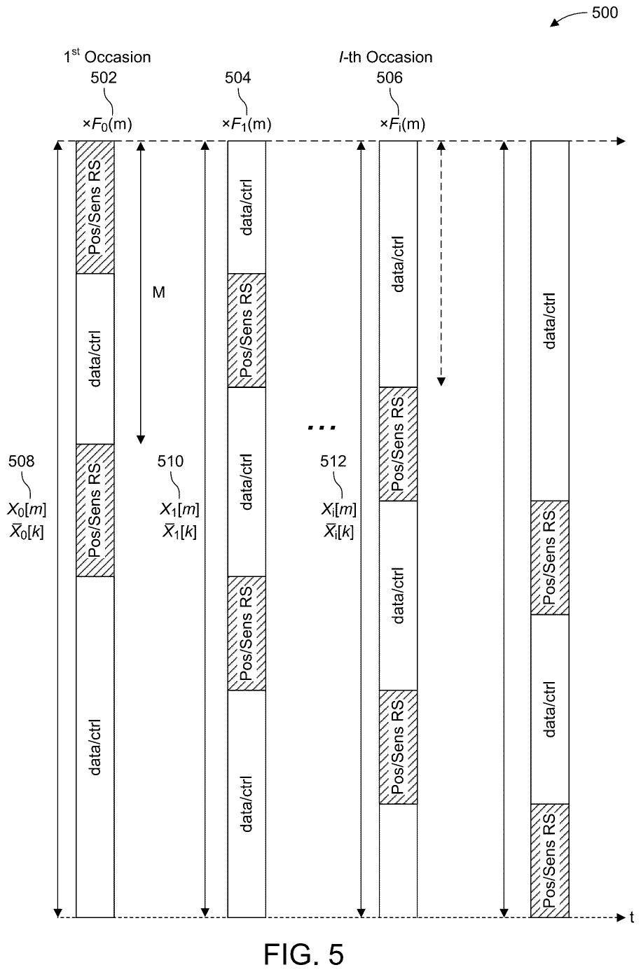

FIG. 5 shows an illustrative example of a pseudo-random frequency hopping pattern 500 being used to overcome unpredictable channel fades, according to one or more embodiments of this disclosure. In an example, transmitted RS version 502 may be expressed as expression 508, RS version 504 may be expressed as expression 510, and RS version 506 may be expressed as expression 512. The RS versions mapped to the resources of a symbol may undergo different frequency allocations to take advantage of the channel's frequency diversity.

In certain representative embodiments, the features of the present disclosure may facilitate performing localization and sensing tasks based on better resilience of CIR measurements against channel aging and fading effects caused by time and frequency dispersion, presence of environment objects, and interference. In certain representative embodiments, features of the present disclosure may also facilitate performing localization and sensing based on a better resolvability of CIR in the time-domain from limited RS bandwidth or a better ability to overcome thermal noise when obtaining CIR.

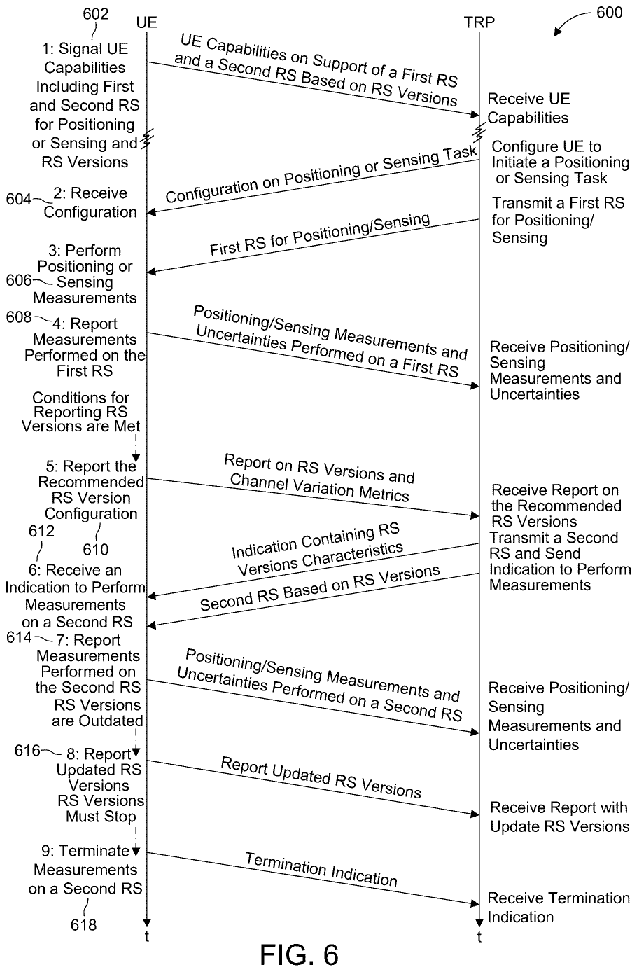

FIG. 6 shows diagram 600 of illustrative actions performed by a WTRU and TRP for a WTRU-assisted selection of RS versions for CIR estimation in localization and sensing, according to one or more embodiments of this disclosure.

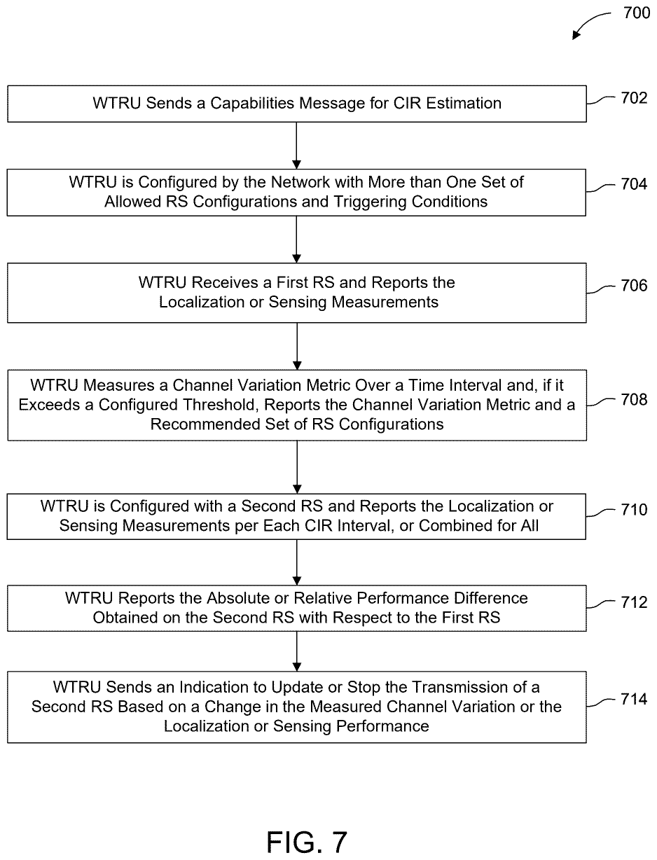

FIG. 7 shows flowchart 700 of illustrative steps for a WTRU-assisted selection of RS versions for CIR estimation, according to one or more embodiments of this disclosure.

In certain representative embodiments, a WTRU receives and decodes a first network request (e.g., received through radio resource control (RRC) signalling) to provide capability information related to the support and reporting of RS versions for CIR estimation in localization and sensing. In certain representative embodiments, a WTRU may receive and decode this first network request following the random-access procedure.

In certain representative embodiments, at step 602, a WTRU may transmit WTRU capabilities on support of a first RS and a second RS based on RS versions, and a TRP may receive the WTRU capabilities. In certain representative embodiments, a WTRU prepares a capabilities information message including information related to the support and reporting of RS versions for CIR estimation in localization or sensing. The information contained in the WTRU capabilities message may include one or more different aspects. In an example, the information may include one or more of support of a first RS for CIR estimation in localization or sensing, support of a second RS for CIR estimation in localization or sensing based on RS versions, supported RS versions for a second RS (e.g., described by version functions stored in its default configuration and/or capabilities list), supported numbers of CIR intervals, supported durations of each CIR interval, allowed CFS values for the supported RS versions (e.g., as indexes in a pre-defined list), supported AI models for RS version determination, supported resource sets for a second RS, supported resource partitioning options (e.g., in one or more of a time, frequency, code, and space domains), or supported frequency-hopping patterns for a second RS (e.g., as indexes in a pre-defined list). In an example, the information may include one or more of localization and/or sensing processing capabilities (e.g., inverse frequency transform capabilities, maximum number of samples), localization and/or sensing frequency ranges, localization and/or sensing bandwidth, sensing modes (e.g., monostatic, bistatic), sensing priorities, localization and/or sensing spatial resolution, support of CIR estimation for localization and/or sensing, support of ToA or TDoA determination and related time resolution for localization and/or sensing, support of AoA determination and related AoA resolution for localization and/or sensing, support of RCS determination, support of RSRPP determination and related power resolution for localization and/or sensing, support of carrier phase measurements and related phase resolution for localization and/or sensing, sensing doppler resolution, reflectivity sensitivity (i.e., the minimum power, SNR, absolute amplitude) for the reflections to be detectable by the WTRU, or localization and sensing related capabilities (e.g., processing capabilities, supported positioning and/or sensing methods, measurements, error sources and/or inaccuracies determination, reporting modes).

In certain representative embodiments, the capabilities message may contain any of the information mentioned in the two previous examples related to the localization capabilities, the sensing capabilities, or both. In certain representative embodiments, the capabilities message may be split in two parts each referring to the localization and sensing capabilities respectively.

In certain representative embodiments, a WTRU may send the WTRU capability information message (e.g., at step 702) through RRC signaling (e.g., over a physical uplink shared channel such as PUSCH).

In certain representative embodiments, WTRU capabilities information may be used by the network to optimize its configuration and allocation of RS versions for CIR estimation in localization or sensing.

In certain representative embodiments, at step 604, a WTRU receives a configuration from a TRP on a positioning or sensing task. In certain representative embodiments, a WTRU is configured by the network to initiate a localization or sensing task by a mechanism of information received (e.g., from a control or data channel via RRC configuration, downlink control indicator (DCI) information, medium access control—control element (MAC CE) signaling). At step 704, a WTRU may be configured by the network with more than one set of allowed RS configurations and triggering conditions.

In certain representative embodiments, general parameters for WTRU-assisted selection of RS patterns for localization or sensing may comprise one or more of several types of information. In an example, a type of information may be the type of localization and/or sensing task according to the service configuration. In an example, a type of information may be information about the RS resources in time, frequency, code and space for CIR estimation in a first and a second RS (e.g., CSI-RS, PRS) such as time/frequency allocation, bandwidth, number of symbols, symbol and comb offsets, periodicity, transmission configuration indication (TCI) states, antenna ports, orthogonal cover codes (OCC) codes, or muting patterns. In an example, a type of information may be a minimum threshold for CIR peaks to be considered by the WTRU in the localization or sensing task (e.g., in any of SNR, RSRPP, accuracy such as an inverse of mean square error (MSE), correlation with the transmitted signal). In an example, a type of information may be an indication to perform sensing measurements on a given sensing area (e.g., determined by a range of SNR, RSRPP) or on one or more target LOS/MPC components, specified by any of their MPC number, ToA, AoA, SNR, or RSRPP over a configured or pre-determined time window. In an example, a type of information may be assistance information to perform inverse frequency transformations for obtaining CIR responses (e.g., frequency range, bandwidth, frequency layer identifier such as positioning frequency layer identifier (PFL-ID), bandwidth part such as bandwidth part identifier (BWP-ID), number of FFT samples). In an example, a type of information may be spatial relationships between antenna ports for sensing (e.g., information about the antenna ports that are co-located in a same TRP and beam such as in the form of configured TCI states with associated quasi co-located (QCL) characteristics). In an example, a type of information may be localization information (e.g., ToA of the LOS component for each sensing TRP, AoAs, coordinates of WTRUs and sensing TRPs, 3D orientation of UE and TRP, LOS likelihoods, WTRU speed). In an example, a type of information may be measurements to perform (e.g., CIR, ToA, TDoA, AoA, absolute or relative RSRPP, RSCP, doppler spectrum, RCS). In an example, a type of information may be reference information for localization and/or sensing (e.g., one or more of the absolute or relative coordinates and the orientation of the WTRU, TRP, a reference object). In an example, a type of information may be target performance values (e.g., as an error or accuracy) to meet (e.g., ToA, TDoA, AoA, RSCP, RSRPP, doppler, RCS).

At step 706, a WTRU may receive a first RS and report the localization or sensing measurements (e.g., to a network).

At step 708, a WTRU measures a channel variation metric over a time interval and, if it exceeds a configured threshold, reports the channel variation metric and a recommended set of RS configurations. In certain representative embodiments, the amount of channel variation can be determined by the WTRU by a mechanism of one or more of several configuration parameters. In an example, a configuration parameter may be a measurement window to determine the channel variation (e.g., number of symbols, slots, frames, a time interval, an index to a list of pre-defined values). In an example, a configuration parameter may be channel variation metrics such as one or more of an absolute change of any of the phase, RSRP, RSRPP, ToA, AoA, or RCS within the measurement period at one or more of the target LOS/MPC components or the value of the Doppler shift, Doppler spread, position, or velocity within the measurement period at any of the target LOS/MPC components. In an example, a configuration parameter may be conditions to detect the channel variation. One such condition may be the value of one or more of the channel variation metrics exceeding a threshold, or set of thresholds, or whether the value of one or more channel variation metrics is inside or outside a range. One other such condition may be the ratio between the SNR or RSRPP of a target LOS/MPC component measured after accumulating the symbols of the measurement window and at the first symbol lower than a configured fraction of the number of symbols (e.g., expressed in decibels, as a percentage, an index in a set of pre-defined values).

At step 710, a WTRU is configured with a second RS and reports the localization or sensing measurements per each CIR interval or combined for all. In certain representative embodiments, available RS versions and resource sets for a second RS, and the conditions for their selection, may comprise of various aspects of information. In an example, an aspect of information may be RS versions and resource sets, which may be given as an index in a discrete set of RS version configurations (e.g., each characterized by their distinctive parameters in time/frequency, density, comb) which may be associated with ranges of supported channel variations for a given measurement metric (e.g., the variation over time of a phase, Doppler, RSRPP, ToA, AoA, RCS). RS versions and resource sets may also be given as an index in a discrete set of RS version functions (e.g., as described by their parameters), one or more allowed CFS values among a set of pre-defined possibilities (e.g., integer multiples of a resource unit such as a subcarrier or group of subcarriers), or one or more resource sets, each specified by any of their time resources (e.g., number of slots, symbols), frequency resources (e.g., no. subcarriers, PRBs), code resources (e.g., OCC codes), and space resources (e.g., antenna ports), including the possibility of a muting pattern. In an example, an aspect of information may be frequency-hopping patterns, each given as an index in a pre-defined set of patterns (e.g., a list of values of M and D). In an example, an aspect of information may be parameters of one or more a-priori known AI models pre-trained to determine the RS version functions. In an example, an aspect of information may be conditions for selection of the size of the CIR interval. These conditions may be such that the size is such that triggering conditions are no longer met within a CIR interval, the size is such that the value of a channel variation metric within a CIR interval is below a threshold, or the size is such that the ratio between the SNR or RSRPP of a target LOS/MPC component measured after accumulating the symbols of the CIR interval and at the first symbol is lower than a configured fraction of the number of symbols (e.g., expressed in decibels, as a percentage, an index in a set of pre-defined values). In an example, an aspect of information may be parameters for selection of the RS versions such as one or more of minimum SNR gain at each CIR interval (e.g., from MRC combining), whether the SNR gain is required to meet the target performance values, minimum phase difference between any two version functions at a configured argument (e.g., an argument equal to the MSE of the ToA or TDoA), or a threshold in any of the SNR, RSRP, or RSRPP to report a frequency-hopping pattern.

In certain representative embodiments, RS version functions are selected to satisfy certain conditions to reinforce CIR estimation. In an example, a condition may be that the sum of the RS version functions is a decreasing function of the argument, the modulus of the sum of the RS version functions approaches the number of RS version functions when the argument approaches zero, the product of a function and its conjugate evaluated at different arguments is equal to the function evaluated at an argument equal to the difference of the two arguments, the product of a function and its conjugate with different CFS values is equal to the function with a CFS equal to the difference of the two CFS values, or any suitable combination of the mentioned conditions.

At step 712, a WTRU reports the absolute or relative performance difference obtained on the second RS with respect to the first RS. In certain representative embodiments, various conditions may trigger the reporting of RS versions. In an example, a condition may be one or more of the channel variation metrics exceeding a threshold, or set of thresholds, or is inside or outside a range, over the configured measurement window. In an example, a condition may be uncertainty in one or more of sensing metrics (e.g., ToA, AoA, SNR, RSRPP, RSCP) of any of the WTRU or sensed targets above a threshold or set of thresholds per each sensing metric. In an example, a condition may be a MSE of any of the position or velocity of the WTRU or sensed targets above a threshold. In an example, a condition may be an SNR or RSRPP below a threshold for the one or more LOS/MPC components corresponding to any of the WTRU or sensed targets. In an example, a condition may be a decrease in the SNR or RSRPP above a threshold for the one or more LOS/MPC components corresponding to any of the UE or sensed targets. In an example, a condition may be a detection of a blocking condition in the LOS path, or a change in the status from LOS to NLOS, for one or more of the TRPs supporting positioning. In an example, a condition may be an explicit indication to report RS versions for one or more multipath components over a configured or pre-determined time window, each specified by any of an MPC number in the estimated CIR, absolute or relative ToA (e.g., with respect to another multipath component), AoA (e.g., specified with respect to a known orientation, or given by the rotation angles, Euler angles), RCS (e.g., in decibel or natural units according to a pre-defined format, or threshold RSRPP or SNR).

At step 714, a WTRU sends an indication to update or stop the transmission of a second RS based on a change in the measured channel variation or the localization or sensing performance. In certain representative embodiments, there may be triggering conditions for updating the report of RS versions by the WTRU. In an example, a triggering condition may be a change in one or more of the channel variation metrics exceeding a threshold, or set of thresholds, or is inside or outside a range, over the configured measurement window. In an example, a triggering condition may be a change in the uncertainty in any of the sensing metrics above a threshold. In an example, a triggering condition may be a change in the MSE of the position or velocity of any of the WTRU or sensed target, or set of sensed targets, above a threshold. In an example, a triggering condition may be a change in any of the SNR, RSRPP, or LOS/NLOS likelihood for the one or more LOS/MPC components corresponding to any of the WTRU or sensed targets above a threshold. In an example, a triggering condition may be a change in the status from LOS to NLOS of one or more of the TRPs supporting positioning. In an example, a triggering condition may be a time elapsed since the last reporting of RS versions exceeding an absolute or relative duration (e.g., a configured periodicity). In an example, a triggering condition may be a WTRU re-configuration message containing updated configuration parameters for reporting of RS versions. In an example, a triggering condition may be a change in the detected RS resources of a second RS (e.g., the birth or death of one or more RS at their configured time-frequency locations, or the corresponding antenna ports). In an example, a triggering condition may be a network request.

In certain representative embodiments, there may be triggering conditions for termination of reporting of RS versions. In an example, a triggering condition may be one or more of the channel variation metrics being below a threshold, or set of thresholds, or is inside or outside a range, over the configured measurement window. In an example, a triggering condition may be uncertainty in one or more of the sensing metrics (e.g., ToA, AoA, SNR, RSRPP, RSCP) of any of the WTRU or sensed targets below a threshold or set of thresholds per each sensing metric. In an example, a triggering condition may be a MSE of any of the position or velocity of any of the WTRU or sensed targets below a threshold. In an example, a triggering condition may be an SNR or RSRPP above a threshold for the one or more LOS/MPC components corresponding to any of the WTRU or sensed targets. In an example, a triggering condition may be a network request containing an indication from the network to fallback to a first RS whose resources may be determined by the configuration or explicitly indicated by their bandwidth, number of symbols, periodicity, TCI states, or antenna ports. In an example, a triggering condition may be a time elapsed since the last reporting of RS versions exceeding a maximum absolute or relative duration. In an example, a triggering condition may be a low-battery indication by the WTRU.

In certain representative embodiments, after receiving a network request for termination of reporting of RS versions, the resources of a first RS to fallback by the WTRU are determined by the configuration of the localization or sensing RS resources for CIR estimation. In certain representative embodiments, the resources of a first RS are explicitly indicated as part of the network request which may contain the bandwidth, number of symbols, periodicity, TCI states, or antenna ports.

In certain representative embodiments, there may be various reporting parameters for WTRU-assisted selection of RS versions. In an example, a reporting parameter may be an available RS version parameter (e.g., a beam index, a CFS). In an example, a reporting parameter may be available frequency-hopping parameters (e.g., an index, a list of values of M and D). In an example, a reporting parameter may be metrics to report on a first and a second RS. These metrics may be one or more channel variation metrics, the location and speed of a WTRU, targets, or environmental objects or the CIR, ToA, TDoA, AoA, RSCP, or Doppler shift of the MPCs in UE-assisted localization or sensing, and respective accuracies or confidence levels for these metrics. In an example, a reporting parameter may be whether localization and sensing measurements on a second RS are reported per each CIR interval or combined for all intervals following a-priori known or configured criteria.

In certain representative embodiments, a WTRU may receive a re-configuration message from the network containing updated configuration parameters for the localization or sensing task (e.g., from a control or data channel via RRC configuration, DCI information, MAC CE signaling). A re-configuration message's reception may override part or all of a configuration previously received by the WTRU.

In certain representative embodiments, a WTRU may receive a first RS for localization or sensing as per the configuration such as in the form of a synchronization signal burst (SSB), CSI-RS, PRS, or a dedicated RS for sensing.

In certain representative embodiments, at step 606, a WTRU may perform positioning or sensing measurements based on a first RS for positioning or sensing. In an example, the WTRU may be configured by the network to measure at least one of the ToA, TDoA, AoA, absolute or relative RSRPP, RSCP, doppler spectrum, or RCS with the associated time from the resources. The WTRU may perform the configured measurement in the allocated measurement time window indicated to the WTRU.

In certain representative embodiments, a time window configuration may consist of at least one of a start or end time of the window (e.g., in terms of symbol index, slot index, frame index, absolute time, relative time with respect to a reference point), a duration of the window (e.g., in terms of number of symbols, slots, frames, subframes, seconds), or a periodicity of the window (e.g., in terms of number of symbols, slots, frames, subframes, seconds).

In certain representative embodiments, the WTRU may receive multiple RSs from one or multiple configured antenna ports for sensing (e.g. from different TRPs and/or single TRP). In that case, the WTRU may perform multiple pre-configured or configured measurements at the different channel responses obtained from the available TRPs and antenna ports for localization or sensing. To accomplish this, the WTRU may perform at least one action from a plurality of actions. In an example, an action may be that the WTRU obtains the channel frequency responses at the configured RS resources (e.g., by removing the known values of the RS complex symbols and performing interpolation of the resulting responses over the desired frequency region). In an example, an action may be that the WTRU obtains the corresponding time-domain CIR responses (e.g., by performing inverse frequency transformations to the obtained frequency responses such as by a mechanism of inverse discrete Fourier transforms). The WTRU, when necessary, may obtain the power delay profile (PDP) responses by computing the absolute square magnitude of the CIR responses. In an example, an action may be that the WTRU obtains the time-domain CIR responses by performing sliding correlations between the received signal and time-shifted versions of the transmitted signal to locate the CIR peaks. In an example, an action may be that the WTRU may keep those CIR or PDP peaks whose powers or SNRs exceed a minimum configured RSRPP or SNR threshold, or whose peak correlation value between the received signal and the transmitted sensing signal is above a threshold, and discard all others. In an example, an action may be that the WTRU may keep the CIR or PDP peaks that are received within a preconfigured ToA or delay window, and discard all the others. In an example, an action may be that the WTRU may compare the CIR or PDP responses against a preconfigured CIR or PDP response expressed as a function of time. The WTRU may select the CIR peaks such that the difference between the pdf of the measured CIR or PDP response, and one or more preconfigured CIR or PDP responses, are below a preconfigured threshold.

In certain representative embodiments, the WTRU may be configured to perform the inverse frequency transformation of the channel frequency responses based on its capability. The WTRU may receive at least one type of assistance information for performing the inverse frequency transformation. In an example, a type of information may be that the network may indicate the RS carrier frequency range where the WTRU may perform the inverse frequency transformation. The network may indicate to the WTRU information in terms of a start/stop frequency (e.g., in terms of Hz, number of REs, number of RBs), frequency offset with respect to an indicated reference frequency (e.g., absolute radio frequency channel number ARFCN), signal bandwidth (e.g., in terms of Hz, number of RBs, number of REs), a frequency layer identifier (e.g., PFL-ID), or a subset of the carrier bandwidth to be used for sensing (e.g., a BWP-ID). In an example, an aspect may be that the WTRU may indicate the number of samples for the frequency transformation (e.g., number of samples for inverse-FFT).

In certain representative embodiments, at step 608, a WTRU may report measurements performed on the first RS. In an example, in a WTRU-based or WTRU-assisted localization or sensing task, a WTRU may send a report for the localization or sensing measurements performed on the scheduled resources of the first RS. The report may be in a compressed or uncompressed mode or as entries in a table. The report may contain one or more types of information. In an example, a type of information may be the antenna ports used in the measurements. In an example, a type of information may be the time stamp of the measurements (e.g., in absolute or relative time, a number of slots, or frames relative to a known reference). In an example, a type of information may be reference signal resources used in the measurements. In an example, a type of information may be one or more scatterer IDs (e.g., a number, a pre-defined label referring to specific peaks in the CIR) or one or more MPC numbers in the CIR. In an example, a type of information may be SNR or RSRPP of the LOS/MPC components being measured. Measurements may be averaged over a specified or pre-determined time window such as by being given as a start and end time (e.g., in terms of symbol index, slot index, frame index, absolute time, relative time with respect to a reference point), or a duration with respect to a given time instant (e.g., in number of symbols, slots, frames, subframes, seconds). In an example, an aspect of information may be the accuracies of localization or sensing measurements (e.g., CIR, ToA, TDoA, AoA, RSRPP, RSCP, doppler spectrum, RCS or a range or a statistical distribution of measured values). A CIR may be reported in different report modes such as in a compressed (e.g., as in NR mode 1) or uncompressed (e.g., as in NR mode 2) form (e.g., as a set of sample values in a pre-defined or configured digital format). If more than one antenna port is involved, representative ToA or AoA values may be provided by, for example, averaging the magnitudes across the antenna ports. ToAs of MPC components for sensing may be reported relative to the ToA of the corresponding LOS component if present or in addition. AoA values may be reported with respect to the AoA of a configured or a-priori known MPC component obtained from the same or a different RS (e.g., a LoS component or a reflected MPC component from another target) or a WTRU orientation vector (e.g., a vector perpendicular to the receive antenna panel or any other predefined WTRU surface whose coordinates can also be reported). AoA values may be expressed as indexes in a table of predefined directions. Measurement accuracies or confidence levels may be given, for example, as the variance or uncertainty in the corresponding magnitudes, or a percentage confidence interval. In an example, a type of information may be an estimated location (e.g., in latitude/longitude, or as coordinates in a suitable reference system) of the WTRU or the target, its speed, and the estimated object type in sensing such as a label of type car, pedestrian, bicycle) with the corresponding accuracies or confidence levels. In certain representative embodiments, the report may be transmitted in an uplink control or data channel (e.g., a physical uplink control channel (PUCCH) or physical uplink control channel (PUSCH)) and may be conveyed by, for example, an RRC control message, uplink control indicator (UCI) signaling, or MAC CE. Reports may be periodic, aperiodic or semi-persistent in accordance with the configuration.

In certain representative embodiments, at step 610, a WTRU may report a recommended RS version configuration to a TRP. In an example, the WTRU may check conditions for triggering the reporting of RS versions. If fulfilled, the WTRU may send to the network a report containing the preferred characteristics of a second RS using RS versions (e.g., via UCI signaling, MAC CE, RRC), targeting the one or more LOS/MPC components in the CIR for which triggering conditions are met.

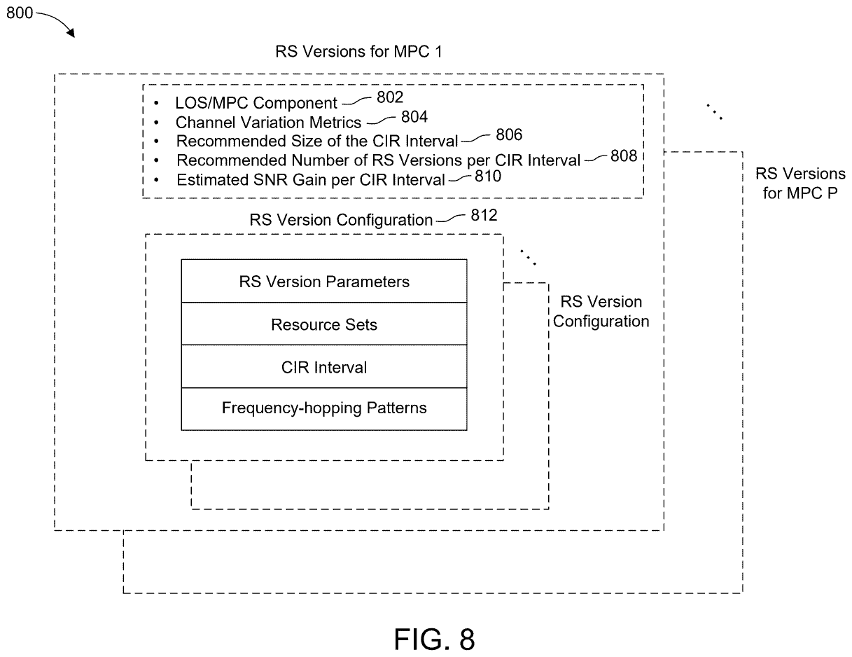

FIG. 8 shows an illustrative report 800 containing the characteristics of the recommended RS versions by the WTRU for up to P many of LOS/MPC components, according to one or more embodiments of this disclosure

In certain representative embodiments, the report from the WTRU may contain one or more types of information for each targeted LOS/MPC components (up to P) that meet the triggering conditions. For example, one type of information may be LOS/MPC component 802 as specified by one or more of an MPC number in CIR, scatterer ID (e.g., a number, a pre-defined label referring to specific peaks in the CIR), SNR or RSRPP, Doppler/velocity (e.g, in Hz, m/s), or estimated accuracy or confidence level (e.g., MSE of the ToA or TDoA). In an example, another type of information may be one or more channel variation metrics 804 over a measurement window. In an example, a type of information may be a recommended size of the CIR interval 806 (e.g., in number of symbols, slots, a duration). In an example, a type of information may be a recommended number of RS versions per CIR interval 808. In an example, one type of information may be estimated SNR gain per CIR interval 810 (e.g., from MRC combining), for example, expressed in decibels, natural units, or an index to a list of pre-defined value. In an example, a type of information may be RS versions configurations 812 expressed as one or more of RS version parameters (e.g., version functions, CFS) that meet the configured conditions, resource sets (e.g., in any of time, frequency, code and space domains), CIR interval, or one or more frequency-hopping patterns (e.g., expressed as an index in a pre-defined set of patterns, a list of values of M and D). In certain representative embodiments, the WTRU may report relevant information for each of the LOS/MPC components that meet the triggering conditions for reporting of RS versions.

In certain representative embodiments, the estimated SNR gain may be obtained from, for example, the SNR from MRC combining of the CIRs as given in eq. (12):

$${SNR}_{gain} = {J}^{2} K , \qquad ( eq . 13 )$$

where J is the number of RS versions and K is the RS spreading gain.

In certain representative embodiments, SNR gain may be represented in a specified digital format such as in compressed or uncompressed mode, for example, as a number of bits or an index in a table of pre-defined values.

In certain representative embodiments, a fast turnaround time may be accomplished by using, for example, DCI or MAC CE signaling to report one or more pre-configured RS versions in a fast way without explicitly reporting their configuration parameters. In an example, the WTRU may store a set of pre-configured lookup tables capturing what the recommended RS versions are as a function of various metrics (e.g., M, L, SNR, signal bandwidth, target MSE). The WTRU may perform a selection without resorting to complex calculations of the CRLB. The selection, coupled with the use of dynamic signaling based on, for example, DCI or MAC CE to report the recommended versions, may achieve a low turnaround time to prevent channel aging effects.

In certain representative embodiments, dynamic signaling may be used by the WTRU to report the RS versions based on, for example, up/down commands issued with reference to a pre-configured lookup table to indicate an RS version, or version function, or version parameter immediately above/before the one currently in use. In certain representative embodiments, signaling may be based on explicit indexes in the pre-configured lookup table. In certain representative embodiments, percentages may be added to profiles to indicate relative confidence levels based on the current conditions. Recommended RS versions may contain a time duration for their use (e.g., in absolute or relative time units, or a number of slots, subframes, frames).

In certain representative embodiments, when mobility is significant, reporting of frequency-hopping patterns under long-term channel conditions (e.g., based on average SNR) may be leveraged by the WTRU to meet a statistical performance target without stressing the network in terms of the resources needed to achieve a short turnaround time.

In certain representative embodiments, at step 612, a WTRU may receive an indication to perform measurements on a second RS after receiving an indication containing RS version characteristics from a TRP. For example, a WTRU may receive from the network (e.g., via DCI signaling, MAC CE, RRC) an indication to perform localization or sensing measurements on a second RS based on RS versions for one or more targeted LOS/MPC components. In certain representative embodiments, the network indication may contain one or more types of information for each of the targeted LOS/MPC components. For example, a type of information may be a targeted LOS/MPC component (e.g., as one or more of a MPC number, scatterer ID, SNR, RSRPP, Doppler/velocity, estimated accuracy or confidence level). In an example, a type of information may be the size of the CIR interval (e.g., in number of symbols, slots). In an example, a type of information may be the number of RS versions per CIR interval. In an example, a type of information may be RS version configurations, each including RS version parameters (e.g., Version functions, CFS), resource sets (e.g., in any of time, frequency, code and space domains), CIR interval, and frequency-hopping patterns (e.g., expressed as an index in a pre-defined set of patterns, a list of values of M and D). In certain representative embodiments, the WTRU may receive relevant information for each of the targeted LOS/MPC components as decided by the network.

In certain representative embodiments, selection of the RS versions by the network may be based on any of the WTRU capabilities, recommended RS versions included in the report for a second RS, channel state, and target performance metrics. The size of the CIR interval, number of RS versions, and RS version configurations may be equal or different to the corresponding recommended information reported by the WTRU.

In certain representative embodiments, at step 614, a WTRU may report measurements performed on the second RS to a TRP. In an example, the WTRU may send a report for the localization or sensing measurements performed on the scheduled resources of the second RS, containing one or more types of information given (e.g., in compressed or uncompressed mode or as entries in a table). In an example, a type of information may be any one, multiple, or any suitable combination of antenna ports used in the measurements, time stamp of the measurements (e.g., in absolute or relative time, or as a number of slots, frames) relative to a known reference, reference signal resources used in the measurements, one or more scatterer IDs (e.g., a number, a pre-defined label referring to specific peaks in the CIR), or one or more MPC numbers in the CIR.

In certain representative embodiments, depending on the configuration, the WTRU may report one or more of the relevant metrics per each of the CIR intervals or combined for all intervals following a-priori known or configured criteria for CIR combining (e.g., MRC combining). In an example, a relevant metric may be SNR or RSRPP of the reported LOS/MPC components. Measurements may be averaged over a specified or pre-determined time window, for example, given as a start and end time (e.g., in terms of symbol index, slot index, frame index, absolute time, relative time with respect to a reference point) or a duration with respect to a given time instant (e.g., in number of symbols, slots, frames, subframes, seconds). In an example, a relevant metric may be one or more channel variation metrics over a measurement window (e.g., the CIR interval, or a specified time interval). In an example, such as in WTRU-assisted localization or sensing, the WTRU may report localization or sensing measurements and their accuracies (e.g., CIR, ToA, TDoA, AoA, RSRPP, RSCP, doppler spectrum, RCS) or a range of a statistical distribution of measured values. In certain representative embodiments, the WTRU may report the absolute or relative performance difference obtained with the second RS with respect to the first RS (e.g., as a percent improvement in the measurement accuracies or confidence levels).

In certain representative embodiments, a network may compare any of the reported measurement accuracies obtained with the second RS and the first RS. In case that the improvement obtained with the second RS is negative, or not as needed to meet the performance requirements, the network may decide to switch to another RS version and override the WTRU's recommendation, or to request a version update to the WTRU. In some cases, the network may detect the presence of a mismatch when the measured SNR or RSRPP of the targeted LOS/MPC components does not match the estimated SNR gain per CIR interval reported by the WTRU for that RS version (e.g., by more than a pre-defined or configured tolerance value). In other cases, the network may detect a mismatch when the localization or sensing measurements reported by the WTRU are indicative of an error (e.g., a position that does not correspond with the expected WTRU/target position at the estimated velocity). In such cases, the network may override the WTRU report or request a version update to the WTRU.

In certain representative embodiments, the report may be transmitted in an uplink control or data channel (e.g., a PUCCH or PUSCH) and may be conveyed by, for example, an RRC control message, UCI signaling, or MAC CE. Reports may be periodic, aperiodic or semi-persistent in accordance with the configuration.

In certain representative embodiments, at step 616, a WTRU reports updated RS versions to a TRP. For example, the WTRU may be configured to report measurements for localization or sensing over one or more measurement occasions on a second RS based on RS versions. The WTRU may determine that the indicated RS versions are outdated, or their corresponding measurements invalidated, based on one or more of the triggering conditions for reporting a RS version update as provided by the network as part of the WTRU configuration.

In certain representative embodiments, based on the triggering conditions for reporting a RS version update, the WTRU may perform new sensing measurements and send to the network an updated report with characteristics of the preferred RS versions in an uplink control or data channel containing one or more of various updates, for example, explicitly through an RRC control message, UCI signaling, or MAC CE. In an example, an update may be an updated LOS/MPC component, specified by one or more of MPC number in the CIR, scatterer ID (e.g., a number, a pre-defined label referring to specific peaks in the CIR), SNR or RSRPP, Doppler/velocity (e.g., in Hz, m/s), or an estimated accuracy or confidence level (e.g., MSE of the ToA or TDoA). In an example, an update may be an updated recommended size of the CIR interval (e.g., in number of symbols, slots, a duration). In an example, an update may be an updated value of one or more of the channel variation metrics (e.g., over the updated recommended size of the CIR interval). In an example, an update may be an updated recommended number of RS versions per CIR interval. In an example, an update may be an updated estimated SNR gain per CIR interval (e.g., from MRC combining), for example, expressed in decibels, natural units, or an index to a list of pre-defined values. In an example, an update may be an updated RS version configuration, expressed as one or more of RS version parameters (e.g., version functions, CFS) that meet the configured conditions, resource sets (e.g., in any of time, frequency, code or space domains), CIR interval, or one or more frequency-hopping patterns (e.g., expressed as an index in a pre-defined set of patterns, a list of values of M and D)

In certain representative embodiments, the WTRU is configured to report measurements for localization or sensing over one or more measurement occasions on a second RS based on RS versions. The WTRU may determine that the indicated RS versions may be terminated for one or more LOS/MPC components, and the WTRU would not further report RS versions for those ones, based on any of the triggering conditions for RS version termination, as provided by the network as part of the WTRU configuration. Based on the determination, the UE may terminate the measurements on a second RS based on RS versions.

In certain representative embodiments, at step 618, a WTRU may terminate measurements on a second RS and transmit a termination indication to a TRP. In an example, when the termination of RS versions is triggered by the WTRU without an explicit network request, the WTRU may send a control signaling message to the network containing a termination indication (e.g., via an uplink control or data channel carrying an RRC message, UCI signaling, or MAC CE).

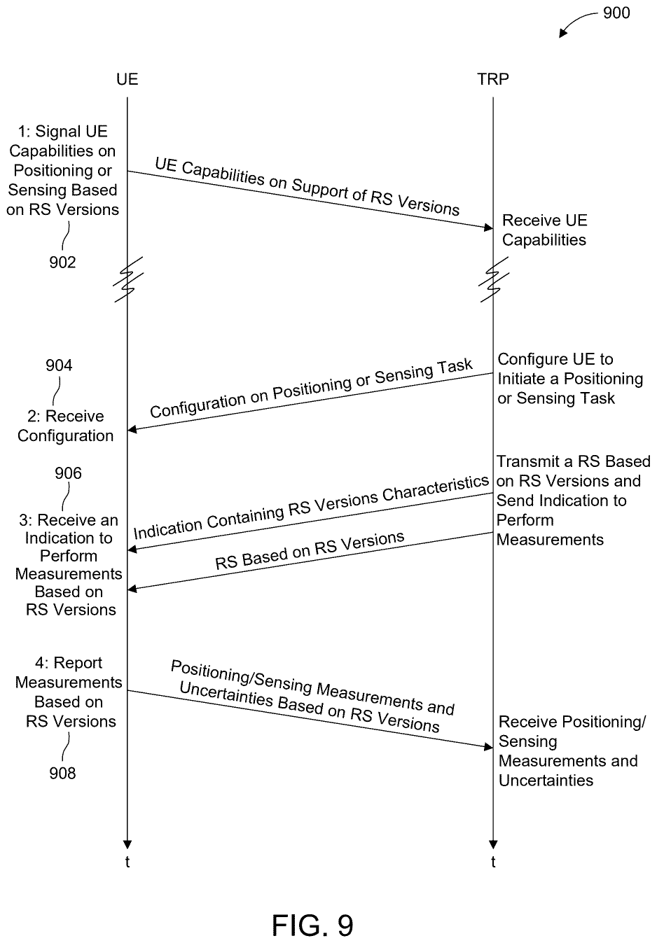

FIG. 9 shows diagram 900 of illustrative actions performed by a WTRU and TRP for localization or sensing measurements based on RS versions, according to one or more embodiments of this disclosure.

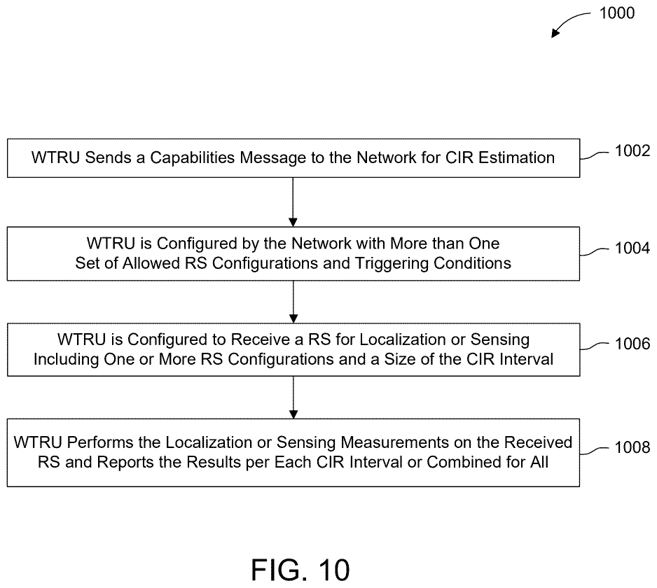

FIG. 10 shows flowchart 1000 of illustrative steps for localization or sensing measurements performed by a WTRU based on RS versions, according to one or more embodiments of this disclosure.

In certain representative embodiments, a WTRU receives and decodes a first network request (e.g., received through RRC signaling) to provide capabilities information related to the support of RS versions for CIR estimation in localization and sensing.

In certain representative embodiments, a WTRU may receive and decode this first network request following a random-access procedure.

In certain representative embodiments, at step 902, a WTRU transmits a WTRU capabilities message to a TRP. In an example, a WTRU may prepare a capabilities information message including information related to the support of RS versions for CIR estimation in localization or sensing. The WTRU capabilities message may include one or more types of information. In an example, a type of information contained in the message may be support of a RS for CIR estimation in localization or sensing based on RS versions, supported RS versions (e.g., described by version functions stored in its default configuration/capabilities list), supported numbers of CIR intervals, supported durations of each CIR interval, allowed CFS values for the supported RS versions (e.g., as indexes in a pre-defined list), supported resource sets and supported resource partitioning options (e.g., in one or more of a time, frequency, code, and space domains), supported frequency-hopping patterns (e.g., as indexes in a pre-defined list), localization and/or sensing processing capabilities (e.g., inverse frequency transform capabilities, maximum number of samples), localization and/or sensing frequency ranges, or localization and/or sensing bandwidth. In an example, a type of information contained in the message may be sensing modes (e.g., monostatic, bistatic), sensing priorities, localization and/or sensing spatial resolution, support of CIR estimation for localization and/or sensing, support of ToA or TDoA determination and related time resolution for localization and/or sensing, support of AoA determination and related AoA resolution for localization and/or sensing, support of RCS determination, support of RSRPP determination and related power resolution for localization and/or sensing, support of carrier phase measurements and related phase resolution for localization and/or sensing, sensing doppler resolution, reflectivity sensitivity (e.g., the minimum power, SNR, absolute amplitude) for the reflections to be detectable by the WTRU, or localization and/or sensing related capabilities, such as processing capabilities, supported positioning/sensing methods, measurements, error sources and/or inaccuracies determination, reporting modes). In certain representative embodiments, the capabilities message may contain any previously mentioned aspects related to the localization capabilities, the sensing capabilities, or both. In certain representative embodiments, the capabilities message may be split in two parts each referring to the localization and sensing capabilities, respectively.

In certain representative embodiments, at step 1002, a WTRU may send the WTRU capability information message through RRC signaling, for example, over a physical uplink shared channel (e.g., PUSCH).

In certain representative embodiments, the WTRU capabilities information may be used by the network to optimize its configuration and allocation of RS versions for CIR estimation in localization or sensing.

In certain representative embodiments, at step 904, a WTRU may receive a configuration from a TRP. In certain representative embodiments, at step 1004, a WTRU is configured by the network with one or more allowed RS configurations in a localization or sensing task. In an example, the WTRU may be configured by the network to initiate a localization or sensing task by a mechanism of one or more aspects of relevant information (e.g., from a control or data channel via RRC configuration, DCI information, MAC CE signaling).

In certain representative embodiments, general parameters for localization or sensing measurements based on RS versions may be comprised of one or more types of relevant information. In an example, a type of relevant information may be the type of localization and/or sensing task according to the service configuration (e.g., a WTRU-based localization service configuration, a WTRU-assisted service configuration, WTRU-based sensing service configuration, or WTRU-assisted service configuration). In an example, a type of relevant information may be information about the RS resources in time, frequency, code and space for CIR estimation in a first and a second RS (e.g., CSI-RS, PRS) such as time/frequency allocation, bandwidth, number of symbols, symbol and comb offsets, periodicity, TCI states, antenna ports, OCC codes, or muting patterns. In an example, a type of relevant information may be a minimum threshold for CIR peaks to be considered by the WTRU in the localization or sensing task (e.g., in any of SNR, RSRPP, accuracy such as an inverse of MSE, correlation with the transmitted signal). In an example, a type of relevant information may be an indication to perform sensing measurements on a given sensing area (e.g., determined by a range of SNR, RSRPP) or on one or more target LOS/MPC components, specified by any of their MPC number, ToA, AoA, SNR, or RSRPP over a configured or pre-determined time window. In an example, a type of relevant information may be assistance information to perform inverse frequency transformations for obtaining CIR responses (e.g., frequency range, bandwidth, frequency layer identifier such as PFL-ID, bandwidth part such as BWP-ID, number of FFT samples). In an example, a type of relevant information may be spatial relationships between antenna ports for sensing (e.g., information about the antenna ports that are co-located in a same TRP and beam such as in the form of configured TCI states with associated QCL characteristics). In an example, a type of relevant information may be localization information (e.g., ToA of the LOS component for each sensing TRP, AoAs, coordinates of WTRUs and sensing TRPs, 3D orientation of UE and TRP, LOS likelihoods, WTRU speed). In an example, a type of relevant information may be measurements to perform (e.g., CIR, ToA, TDoA, AoA, absolute or relative RSRPP, RSCP, doppler spectrum, RCS). In an example, a type of relevant information may be reference information for localization and/or sensing (e.g., one or more of the absolute or relative coordinates and the orientation of the WTRU, TRP, a reference object). In an example, a type of relevant information may be target performance values (e.g., as an error or accuracy) to meet (e.g., ToA, TDoA, AoA, RSCP, RSRPP, doppler, RCS). It may be understood that one, multiple, or any suitable combination of the previously mentioned aspects may be considered a general parameter for localization or sensing measurements based on RS versions.

In certain representative embodiments, the amount of channel variation may be determined by the WTRU by a mechanism of one or more of several configuration parameters. In an example, a configuration parameter may be a measurement window to determine the channel variation (e.g., number of symbols, slots, frames, a time interval, an index to a list of pre-defined values). In an example, a configuration parameter may be channel variation metrics such as one or more of an absolute change of any of the phase, RSRP, RSRPP, ToA, AoA, or RCS within the measurement period at one or more of the target LOS/MPC components or the value of the Doppler shift, Doppler spread, position, or velocity within the measurement period at any of the target LOS/MPC components.

In certain representative embodiments, available RS versions and resources sets may comprise of one or more types of relevant information. In an example, a type of relevant information may be RS versions and resource sets, which may be given as an index in a discrete set of RS version configurations (e.g., each characterized by their distinctive parameters in time/frequency, density, comb) RS versions and resource sets may also be given as an index in a discrete set of RS version functions (e.g., as described by their parameters), one or more allowed CFS values among a set of pre-defined possibilities (e.g., integer multiples of a resource unit such as a subcarrier or group of subcarriers), or one or more resource sets, each specified by any of their time resources (e.g., number of slots, symbols), frequency resources (e.g., no. subcarriers, PRBs), code resources (e.g., OCC codes), and space resources (e.g., antenna ports), including the possibility of a muting pattern. In an example, a type of relevant information may be frequency-hopping patterns, each given as an index in a pre-defined set of patterns (e.g., a list of values of M and D).

In certain representative embodiments, RS version functions are selected to satisfy certain conditions to reinforce CIR estimation. In an example, a condition may be that the sum of the RS version functions is a decreasing function of the argument, the modulus of the sum of the RS version functions approaches the number of RS version functions when the argument approaches zero, the product of a function and its conjugate evaluated at different arguments is equal to the function evaluated at an argument equal to the difference of the two arguments, the product of a function and its conjugate with different CFS values is equal to the function with a CFS equal to the difference of the two CFS values, or any suitable combination of the mentioned conditions.

In certain representative embodiments, reporting parameters for localization or sensing based on RS versions may comprise of one or more metrics. In an example, reporting parameters may include metrics to report (e.g., one or more channel variation metrics, the location and speed of UE, targets, environmental objects) in WTRU-based localization or sensing. Reporting parameters may also include the CIR, ToA, TDoA, AoA, RSCP, Doppler shift, and/or any other related metric of the MPCs (in WTRU-assisted localization or sensing, and their accuracies or confidence levels. In certain representative embodiments, WTRU may receive a re-configuration message from the network containing updated configuration parameters for the localization or sensing task (e.g., from a control or data channel via RRC configuration, DCI information, MAC CE signaling). The reconfiguration message may contain part or all of the previously mentioned reporting parameters and its reception may override part or all of a configuration previously received by the WTRU.

In certain representative embodiments, at step 906, a WTRU may receive an indication to perform measurements based on RS versions from a TRP. In certain representative embodiments, at step 1006, a WTRU may be configured to receive a RS for localization or sensing including one or more RS configurations and a size of the CIR interval. In an example, a WTRU may receive from the network (e.g., via DCI signaling, MAC CE, RRC) an indication to perform localization or sensing measurements based on RS versions for one or more targeted LOS/MPC components.

In certain representative embodiments, a network indication may contain one or more types of relevant information for each of the targeted LOS/MPC components. In an example, a type of relevant information for each of the targeted LOS/PMC components may be the actual targeted LOS/MPC component (e.g., as one or more of a MPC number, scatterer ID, SNR, RSRPP, Doppler/velocity, estimated accuracy or confidence level), the size of the CIR interval (e.g., in number of symbols, slots), or the number of RS versions per CIR interval. In an example, a type of relevant information may be RS version configurations, each including RS version parameters (e.g., version functions, CFS), resource sets (e.g., in any of time, frequency, code and space domains), CIR interval, and frequency-hopping patterns (e.g., expressed as an index in a pre-defined set of patterns, a list of values of M and D). In certain representative embodiments, the WTRU may receive the above information for each of the targeted LOS/MPC components as decided by the network.

In certain representative embodiments, at step 908, a WTRU may report measurements based on RS versions to a TRP. In certain representative embodiments, at step 1008, a WTRU performs the localization or sensing measurements on the received RS and reports the results per each CIR interval or combined for all. In an example, the WTRU may send a report for the localization or sensing measurements performed on the scheduled resources of the RS, containing one or more types of relevant information given (e.g., in compressed or uncompressed mode or as entries in a table). In an example, type of relevant information may be any one, multiple, or any suitable combination of antenna ports used in the measurements, time stamp of the measurements (e.g., in absolute or relative time, or as a number of slots, frames) relative to a known reference, reference signal resources used in the measurements, one or more scatterer IDs (e.g., a number, a pre-defined label referring to specific peaks in the CIR), or one or more MPC numbers in the CIR.

In certain representative embodiments, depending on the configuration, the WTRU may report one or more metrics per each of the CIR intervals, or combined for all intervals following a-priori known or configured criteria for CIR combining (e.g., MRC combining). In an example, a metric may be SNR or RSRPP of the LOS/MPC components being measured. Measurements may be averaged over a specified or pre-determined time window such as by being given as a start and end time (e.g., in terms of symbol index, slot index, frame index, absolute time, relative time with respect to a reference point), or a duration with respect to a given time instant (e.g., in number of symbols, slots, frames, subframes, seconds). In an example, a metric may be one or more channel variation metrics over a measurement window (e.g., the CIR interval, or a specified time interval). In an example, a metric may be the accuracies of localization or sensing measurements (e.g., CIR, ToA, TDoA, AoA, RSRPP, RSCP, doppler spectrum, RCS or a range or a statistical distribution of measured values). A CIR may be reported in different report modes such as in a compressed (e.g., as in NR mode 1) or uncompressed (e.g., as in NR mode 2) form (e.g., as a set of sample values in a pre-defined or configured digital format). If more than one antenna port is involved, representative ToA or AoA values may be provided by, for example, averaging the magnitudes across the antenna ports. ToAs of MPC components for sensing may be reported relative to the ToA of the corresponding LOS component if present or in addition. AoA values may be reported with respect to the AoA of a configured or a-priori known MPC component obtained from the same or a different RS (e.g., a LoS component or a reflected MPC component from another target) or a WTRU orientation vector (e.g., a vector perpendicular to the receive antenna panel or any other predefined WTRU surface whose coordinates can also be reported). AoA values may be expressed as indexes in a table of predefined directions. Measurement accuracies or confidence levels may be given, for example, as the variance or uncertainty in the corresponding magnitudes, or a percentage confidence interval. In an example, a type of relevant information may be an estimated location (e.g., in latitude/longitude, or as coordinates in a suitable reference system) of the WTRU or the target, its speed, and the estimated object type in sensing such as a label of type car, pedestrian, bicycle) with the corresponding accuracies or confidence levels. In certain representative embodiments, the report may be transmitted in an uplink control or data channel (e.g., a PUCCH or PUSCH) and may be conveyed by, for example, an RRC control message, UCI signaling, or MAC CE. Reports may be periodic, aperiodic or semi-persistent in accordance with the configuration.

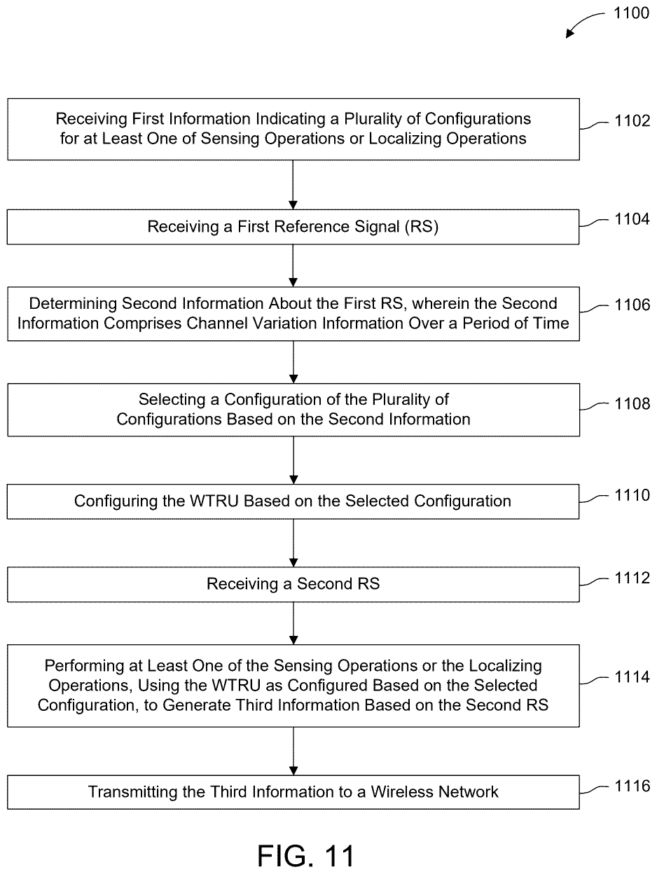

FIG. 11 shows flowchart 1100 of illustrative steps for selecting a RS configuration, according to one or more embodiments of this disclosure.

At step 1102, a WTRU may receive first information indicating a plurality of configurations for at least one of sensing operations or localizing operations. In certain representative embodiments, the WTRU may receive the first information from a wireless network. In certain representative embodiments, the first information further indicates conditions for triggering measurement and reporting associated with at least one of the sensing operations or the localizing operations, and wherein each of the plurality of configurations comprises respective parameters associated with respective channel variations. In certain representative embodiments, a WTRU may select an initial configuration from the plurality of configurations, be configured based on the initial configuration, and perform at least one of the sensing operations or the localizing operations, using the configuration, which is based on the initial configuration, to generate information based on the first RS. The information generated based on the first RS may be transmitted to the wireless network. In certain representative embodiments, the information based on the first RS may indicate at least one of a LOS/MPC, one or more channel variation information over a measurement window, a recommended size of a CIR interval, a recommended number of RS versions per CIR interval, estimated SNR ratio gain per CIR interval, or RS version configurations. In certain representative embodiments, the WTRU may perform step 1102 in lieu of, in conjunction with, or in addition to any one of steps 702-706.

At step 1104, a WTRU may receive, from the wireless network, a first RS.

At step 1106, the WTRU may determine second information about the first RS, wherein the second information comprises channel variation information over a period of time. In certain representative embodiments, channel variation information comprises at least one of a change in phase, a change in RSRP, a change in RSRPP, a change in ToA, a change in AoA, a change in RCS, a doppler shift, a doppler spread, a change in position, or change in velocity, wherein any of the changes may correspond to the first RS over the period of time. In certain representative embodiments, the WTRU may perform any one of steps 1102-1106 in lieu of, in conjunction with, or in addition to any one of steps 602-608. In certain representative embodiments, the WTRU may perform any one of steps 1102-1106 in lieu of, in conjunction with, or in addition to any one of steps 706-708.

At step 1108, the WTRU may select a configuration of the plurality of configurations based on the second information.

At step 1110, configuring the WTRU based on the selected configuration.

At step 1112, the WTRU may receive, from the wireless network, a second RS.

At step 1114, the WTRU may perform at least one of the sensing operations or the localizing operations, using the WTRU as configured based on the selected configuration, to generate third information based on the second RS. In certain representative embodiments, the third information comprises measurements for each interval of a plurality of CIR intervals of the second RS. In certain representative embodiments, the WTRU may perform any one of steps 1108-1114 in lieu of, in conjunction with, or in addition to any one of steps 612-614. In certain representative embodiments, the WTRU may perform any one of steps 1108-1112 in lieu of, in conjunction with, or in addition to any one of steps 710-712.

At step 1116, the WTRU may transmit the third information to the wireless network. In certain representative embodiments, the third information comprises measurements for each interval of a plurality of CIR intervals of the second RS. In certain representative embodiments, transmitting the third information to the wireless network comprises transmitting, to the wireless network, a report (e.g., report 800) comprising at least one of: sensing measurements, localization measurements, measurement antenna ports, measurement time stamps, measurement identifiers or possible measurement ranges. In certain representative embodiments, the WTRU may transmit, to the wireless network, an indication to one of update or stop transmission of the second RS based on at least one of the determined absolute performance difference or relative performance difference, wherein the absolute or relative performance difference is based at least in part on a difference between information from the second RS with respect to information from the first RS. In certain representative embodiments, the WTRU may perform step 1116 in lieu of, in conjunction with, or in addition to any one of steps 614-618. In certain representative embodiments, the WTRU may perform any one of steps 1114-1116 in lieu of, in conjunction with, or in addition to any one of steps 712-714.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations or processes described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the means of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, or a computer memory, and a transmission type medium such as a digital and/or an analog communication medium (e.g., a fiber optic cable, a waveguide, a wired communications link, a wireless communication link).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to”). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together). In those instances where a convention analogous to “at least one of A, B, or C.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths. As a non-limiting example, each range discussed herein may be readily broken down into a lower third, middle third and upper third. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU), the method comprising:
receiving, from a wireless network, first information indicating a plurality of configurations for at least one of sensing operations or localizing operations;
receiving, from the wireless network, a first reference signal (RS);
determining second information about the first RS, wherein the second information comprises channel variation information over a period of time;
selecting a configuration of the plurality of configurations based on the second information;
configuring the WTRU based on the selected configuration;
receiving, from the wireless network, a second RS;
performing at least one of the sensing operations or the localizing operations, using the WTRU as configured based on the selected configuration, to generate third information based on the second RS; and
transmitting the third information to the wireless network.

2. The method of claim 1, further comprising:
selecting an initial configuration from the plurality of configurations;
configuring the WTRU based on the initial configuration;
performing at least one of the sensing operations or the localizing operations, using the WTRU as configured based on the initial configuration, to generate fourth information based on the first RS; and
transmitting the fourth information to the wireless network.

3. The method of claim 2, wherein the fourth information indicates at least one of a line of sight/multipath component, one or more channel variation information over a measurement window, a recommended size of a channel impulse response (CIR) interval, a recommended number of RS versions per CIR interval, estimated signal-to-noise ratio gain per CIR interval, or RS version configurations.

4. The method of claim 2, further comprising:
determining at least one of an absolute performance difference or a relative performance difference obtained from the third information based on the second RS with respect to the fourth information based on the first RS; and
transmitting the at least one of the absolute performance difference or the relative performance difference to the wireless network.

5. The method of claim 4, further comprising transmitting, to the wireless network, an indication to one of update or stop transmission of the second RS based on at least one of the determined absolute performance difference or relative performance difference.

6. The method of claim 1, wherein the first information further indicates conditions for triggering measurement and reporting associated with at least one of the sensing operations or the localizing operations, and wherein each of the plurality of configurations comprises respective parameters associated with respective channel variations.

7. The method of claim 1, wherein the channel variation information comprises at least one of a change in phase, a change in reference signal received power (RSRP), a change in reference signal received power per path (RSRPP), a change in time of arrival (ToA), a change in angle of arrival (AoA), a change in radar-cross section (RCS), a doppler shift, a doppler spread, a change in position, or change in velocity, wherein any of the changes may correspond to the first RS over the period of time.

8. The method of claim 1, wherein transmitting the third information to the wireless network comprises transmitting, to the wireless network, at least one of: sensing measurements, localization measurements, measurement antenna ports, measurement time stamps, measurement identifiers or possible measurement ranges.

9. The method of claim 1, further comprising:
receiving, from the wireless network, a request to provide capabilities information;
generating the capabilities information based on the request; and
transmitting the capabilities information to the wireless network, wherein the capabilities information indicates support of at least the plurality of configurations.

10. The method of claim 1, wherein the third information comprises measurements for each interval of a plurality of channel impulse response (CIR) intervals of the second RS.

11. A wireless transmit/receive unit (WTRU) comprising:
a processer; and
a transceiver, wherein the WTRU is configured to:
receive, from a wireless network, first information indicating a plurality of configurations for at least one of sensing operations or localizing operations;
receive, from the wireless network, a first reference signal (RS);
determine second information about the first RS, wherein the second information comprises channel variation information over a period of time;
select a configuration of the plurality of configurations based on the second information;
configure the WTRU based on the selected configuration;
receive, from the wireless network, a second RS;
perform at least one of the sensing operations or the localizing operations, using the WTRU as configured based on the selected configuration, to generate third information based on the second RS; and
transmit the third information to the wireless network.

12. The WTRU of claim 11, wherein the WTRU is further configured to:
select an initial configuration from the plurality of configurations;
configure the WTRU based on the initial configuration;
perform at least one of the sensing operations or the localizing operations, using the WTRU as configured based on the initial configuration, to generate fourth information based on the first RS; and
transmit the fourth information to the wireless network.

13. The WTRU of claim 12, wherein the fourth information indicates at least one of a line of sight/multipath component, one or more channel variation information over a measurement window, a recommended size of a channel impulse response (CIR) interval, a recommended number of RS versions per CIR interval, estimated signal-to-noise ratio gain per CIR interval, or RS version configurations.

14. The WTRU of claim 12, wherein the WTRU is further configured to:
determine at least one of an absolute performance difference or a relative performance difference obtained from the third information based on the second RS with respect to the fourth information based on the first RS; and
transmit the at least one of the absolute performance difference or the relative performance difference to the wireless network.

15. The WTRU of claim 14, wherein the WTRU is further configured to transmit, to the wireless network, an indication to one of update or stop transmission of the second RS based on at least one of the determined absolute performance difference or relative performance difference.

16. The WTRU of claim 11, wherein the first information further indicates conditions for triggering measurement and reporting associated with at least one of the sensing operations or the localizing operations, and wherein each of the plurality of configurations comprises respective parameters associated with respective channel variations.

17. The WTRU of claim 11, wherein the channel variation information comprises at least one of a change in phase, a change in reference signal received power (RSRP), a change in reference signal received power per path (RSRPP), a change in time of arrival (ToA), a change in angle of arrival (AoA), a change in radar-cross section (RCS), a doppler shift, a doppler spread, a change in position, or change in velocity, wherein any of the changes may correspond to the first RS over the period of time.

18. The WTRU of claim 11, wherein transmitting the third information to the wireless network comprises transmitting, to the wireless network, at least one of: sensing measurements, localization measurements, measurement antenna ports, measurement time stamps, measurement identifiers or possible measurement ranges.

19. The WTRU of claim 11, wherein the WTRU is further configured to:
receive, from the wireless network, a request to provide capabilities information;
generate the capabilities information based on the request; and
transmit the capabilities information to the wireless network, wherein the capabilities information indicates support of at least the plurality of configurations.

20. The WTRU of claim 11, wherein the third information comprises measurements for each interval of a plurality of channel impulse response (CIR) intervals of the second RS.
